(19) United States
(12) Patent Application Publication
(10) Pub. No.: US 2016/0210658 A1
(43) Pub. Date: Jul. 21, 2016

(54) DETERMINING TOUCHPOINT ATTRIBUTIONS IN A SEGMENTED MEDIA CAMPAIGN

(71) Applicants: Anto Chittilappilly, Waltham, MA (US); Payman Sadegh, Alpharetta, GA (US)

(72) Inventors: Anto Chittilappilly, Waltham, MA (US); Payman Sadegh, Alpharetta, GA (US)

(21) Appl. No.: 14/973,246

(22) Filed: Dec. 17, 2015

Related U.S. Application Data
(60) Provisional application No. 62/099,074, filed on Dec. 31, 2014.

(51) Int. Cl. G06Q 30/02; G06N 99/00

(52) U.S. Cl. CPC G06Q 30/0246; G06Q 30/0201; G06Q 30/0204; G06N 99/005

(57) ABSTRACT

The present disclosure provides a detailed description of techniques used in systems, methods, and computer program products for determining marketing touchpoint attributions in a segmented media campaign. Embodiments commence by forming a touchpoint attribution predictive model based on stimulus data records and Internet-collected touchpoint data records. A set of media campaign segments can be received or derived and then used for selecting corresponding segment touchpoint data records. Segmented touchpoint contribution values for the media campaign segments are generated by applying the segment touchpoint data records to the touchpoint attribution predictive model. The segmented touchpoint contribution values serve to relate a segment of users with varying engagement states experienced by that segment of users. Spending recommendations are emitted based on predictions that an increase in user interactions at specific touchpoints by a certain segment of users will measurably advance the engagement of that segment of users.

The present application claims the benefit of priority to co-pending U.S. Patent Application Ser. No. 62/099,074, entitled “MARKETING TOUCHPOINT ATTRIBUTIONS IN A SEGMENTED MEDIA CAMPAIGN” (Attorney Docket No. VISQ.P0016P), filed Dec. 31, 2014 which is hereby incorporated by reference in its entirety.

### FIELD OF THE INVENTION

The present disclosure relates to the field of managing an Internet advertising campaign and more particularly to techniques for media attribution in a multipoint media campaign.

### BACKGROUND

The prevalence of Internet advertising and marketing continues to grow at a fast pace. In the earliest days of Internet advertising and marketing, a direct correlation between online clicks (e.g., on a product banner ad) and the revenue generated by those clicks (e.g., purchase of the product) could be established. In reviewing correspondence between clicks and revenue generated, a marketing manager might decide to spend more of the marketing budget on securing clicks (e.g., increase the frequency and reach of banner ads) with the intent to further increase revenue that is correlated to those clicks. Today, however, an online user (e.g., prospect) in a given target audience can experience a significantly higher number of exposures to a brand and product (e.g., touchpoints) across multiple channels using different media (e.g., online display, online search, TV ad, radio spot, print, etc.) on his/her journey to conversion (e.g., buying a product, etc.) and/or to some other engagement state (e.g., brand introduction, brand awareness, etc.). Further, another online user in the same target audience might experience a different combination or permutation of touchpoints and channels, yet might not convert. The marketing manager of today desires to learn exactly what touchpoints contributed the most t conversions and/or engagement state transitions in order to appropriately allocate the marketing budget to those tactics.

Various techniques for calculating the attribution of touchpoints to media campaign responses e.g., conversions) have been considered. Such attribution calculations are largely enabled not only by the voluminous online user activity data available (e.g., cookies, pixel tags, mobile tracking, etc.), hut also by various offline data available (e.g., in-store purchase records, etc.). However, certain biases are inherent in the attribution data and calculations thereto. Specifically, legacy approaches are rudimentary, at least in the sense that the legacy approaches consider the progression from “nowhere” (e.g., no measurable engagement) “conversion” as a single state transition, Further, legacy approaches consider all users in a given target audience as having an equal propensity to convert. With such approaches, a user's engagement state, derived from certain touchpoint attributes (e.g., impression event, click event, etc.) and/or user profile attributes (e.g., gender, age, occupation, etc.) is not considered when attributing credit to media touchpoints. In such rudimentary cases, the accuracy of the attribution results is limited.

Specifically, the attribution results can have a bias that is attributed to an unknown (e.g., “organic”) cause. For example, a retargeting ad for a certain website (e.g., “20% off a one-year subscription to WSJ.com”) might get full credit for a conversion even when the user already had a certain propensity (e.g., advanced engagement e or readiness state) to visit that website before seeing the retargeting ad, such as due to an intrinsic propensity and/or personal attribute (e.g., works in financial industry, etc.). Without information related to a particular user's engagement state being applied to the touchpoint attributions, the marketing manager might not be aware of the bias (e.g., due to the intrinsic propensity) and apportion too much of the marketing budget to the retargeting ad. Further, in some cases, the marketing manager might apportion too little to certain other touchpoints that might improve the user's propensity to convert and/or facilitate a transition to a next engagement state.

Techniques are therefore needed address the problem of accurately determining marketing touchpoint attribution among users with varying engagement states. None of the aforementioned legacy approaches achieve the capabilities of the herein-disclosed techniques for determining marketing touchpoint attributions in a segmented media. campaign. Therefore, there is a need for improvements.

### SUMMARY

The present disclosure provides an improved system, method, and computer program product suited to address the aforementioned issues with legacy approaches. More specifically, the present disclosure provides a detailed description of techniques used in systems, methods, and computer program products for determining marketing touchpoint attributions in a segmented media campaign.

Some embodiments commence by forming a touchpoint attribution predictive model based on stimulus data records and Internet-collected touchpoint data records. A set of media campaign segments can be received or derived and then used for selecting corresponding segment touchpoint data records (e.g., as determined from the touchpoint data records associated with the media campaign segments). Segmented touchpoint contribution values for the media campaign segments are generated by applying the segment touchpoint data records to the touchpoint attribution predictive model. The segmented touchpoint contribution values serve to relate a segment of users with varying engagement states experienced by that of users. Spending is automatically apportioned based on predictions that an increase in user interactions at specific touchpoints by a certain segment of users will measurably advance the engagement of that segment of users.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A depicts techniques for determining marketing touchpoint attributions in a segmented media. campaign, according to some embodiments.

FIG. 1B depicts an environment in which embodiments of the present disclosure can operate.

FIG. 2A is a touchpoint attribute chart showing sample attributes associated with touchpoints of a media campaign, according to some embodiments.

FIG. 2B is a diagram depicting data structures used to associate user profile information with touchpoints of a media campaign, according to some embodiments.

FIG. 3A illustrates a touchpoint attribution technique, according to some embodiments.

FIG. 3B depicts an attribution bias removal technique 3B00 facilitated by systems for determining marketing touchpoint attributions in a segmented media campaign, according to some embodiments.

FIG. 4A depicts an engagement state diagram showing a segmented user engagement progression and associated events, according to some embodiments.

FIG. 48 depicts an event-based segment attribution technique for determining marketing touchpoint attributions in a segmented media campaign, according to some embodiments.

FIG. 5A depicts an engagement state diagram showing a segmented user engagement progression and associated audience segments.

FIG. 5B depicts a profile-based segment attribution technique for determining marketing touchpoint attributions in a segmented media campaign, according to some embodiments.

FIG. 6 depicts a subsystem for determining marketing to point attributions in a segmented media campaign, according to some embodiments.

FIG. 7 depicts a flowchart for determining marketing touchpoint attributions in a segmented media campaign, according to some embodiments.

FIG. 8A and FIG. 8B are block diagrams of systems for determining marketing touchpoint attributions in a segmented media campaign, according to an embodiment.

FIG. 9A and FIG. 9B depict block diagrams of computer system components suitable for implementing embodiments of the present disclosure.

### DETAILED DESCRIPTION

Certain aspects in some embodiments of the present application are related to material disclosed in U.S. patent application Ser. No. 14/465,838, entitled “APPORTIONING A MEDIA CAMPAIGN CONTRIBUTION TO A MEDIA CHANNEL IN THE PRESENCE OF AUDIENCE SATURATION” (Attorney Docket No. VISQ.P0021) filed. on Aug. 21, 2014, and certain aspects in some embodiments of the present application are related to material disclosed in U.S. patent application Ser. No. 14/969,773, entitled “MARKETING TOUCHPOINT ATTRIBUTION BIAS CORRECTION” (Attorney Docket No. VISQ.P0012) filed on Dec. 15, 2015, the contents of which are hereby incorporated by reference in their entirety.

### Overview

The prevalence of Internet advertising and marketing continues to grow at a fast pace. In the earliest days of Internet advertising and marketing, a direct correlation between online clicks (e.g., on a product banner ad) and the revenue generated by those clicks (e.g., purchase of the product) be established. In reviewing correspondence between clicks and revenue generated, a marketing manager might decide to spend more of the marketing budget on securing clicks (e.g., increase the frequency and reach of banner ads) with the intent to further increase revenue correlated to those clicks. Today, however, an online user (e.g., prospect) in a given target audience can experience a significantly higher number of exposures to a brand and product (e.g., touchpoints) across multiple channels using different media (e.g., online display, online search, TV ad, radio spot, print, etc. on the journey to conversion (e.g., buying a product, etc.) and/or to some other engagement state (e.g., brand introduction, brand awareness, etc.). Further, another online user in the same target audience might experience a different combination or permutation of touchpoints and channels, yet might not convert. The marketing manager of today desires to learn exactly what touchpoints contributed the most to conversions in order to appropriately allocate the marketing budget to those tactics.

Various techniques for calculating the attribution of touchpoints to media campaign responses (e.g., conversions) have been considered. Such attribution calculations are largely enabled not only by the voluminous online user activity data available (e.g., cookies, pixel tags, mobile tracking, etc.), but also by various offline data available (e.g., in-store purchase records, etc.). However, certain biases are inherent in the attribution data and calculations thereto, and without information related to a particular user's (or group of similar users') engagement state being applied to the touchpoint attributions, the marketing manager might apportion too much of the marketing budget to the retargeting ad, and might apportion too little to other touchpoints that might improve the user's propensity to convert and/or facilitate a transition to a next engagement state.

The techniques disclosed herein apply the touchpoints associated with a media campaign segment to a touchpoint attribution predictive model to generate touchpoint attributions for the media campaign segment. The media campaign can be segmented by certain events (e.g., user clicks on ads) and/or user attributes (e.g., male, married, etc.) that can be associated with one or more engagement states (e.g., no engagement, demonstrated brand awareness, measurable product interest, verified conversion, another intermediate engagement level, etc.). A segment can be bounded by a first engagement state and a second engagement state and/or defined by one or more user profile categories. With this approach, the marketing manager can apportion the marketing budget to touchpoints that measurably advance the engagement of a certain segment of users based on a propensity to advance that is associated with the particular segment.

### Definitions

Some of the terms used in this description are defined below for easy reference, The presented terms and their respective definitions are not rigidly restricted to these definitions—a term may be further defined b the term's use within this disclosure.

The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

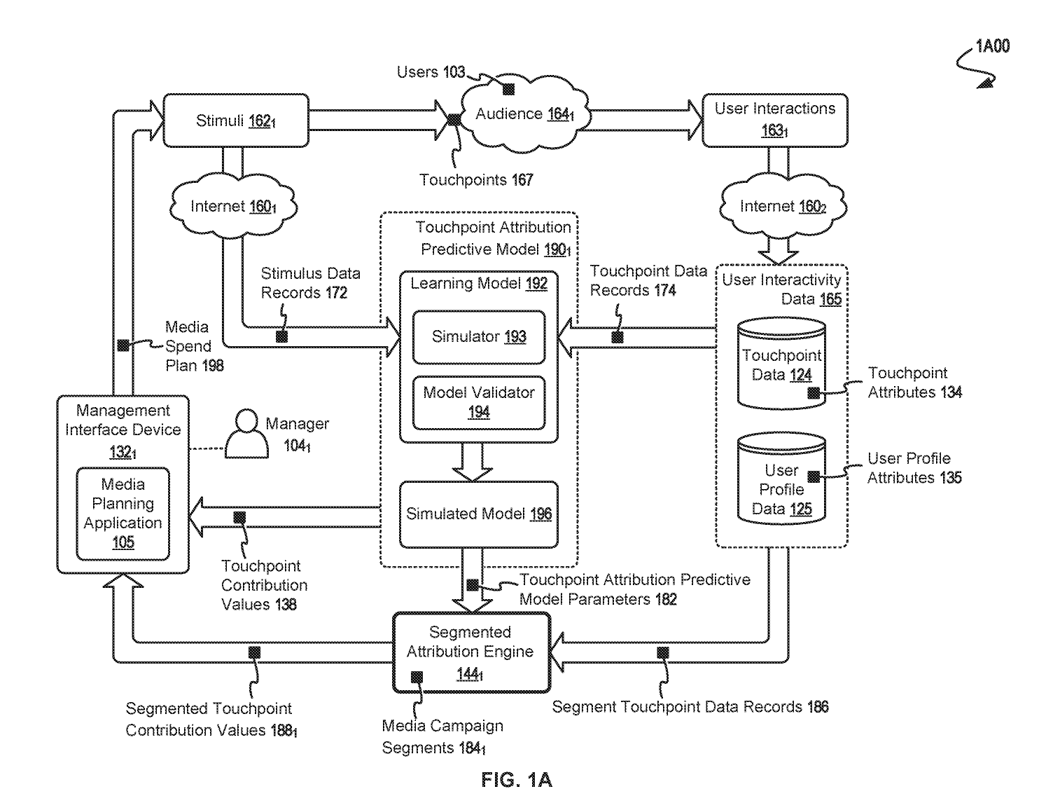

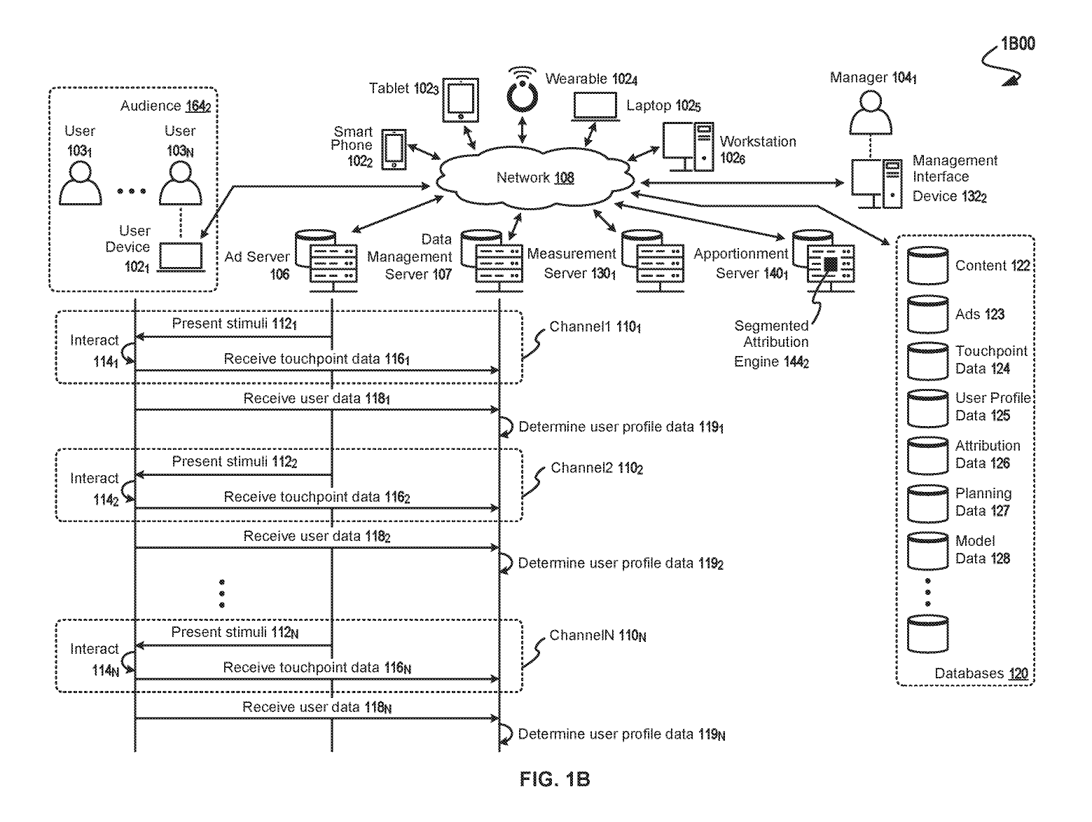

FIG. 1A depicts techniques 1A00 for determining marketing touchpoint attributions in a segmented media campaign, according to some embodiments. As an option, one or more instances of techniques 1A00 or any aspect thereof may be implemented in the context of the architecture and functionality of the embodiments described herein. Also, techniques 1A00 or any aspect thereof may be implemented in any desired environment.

One approach to optimizing media spend apportionment uses marketing response predictions and attributions determined from historical data. Analysis of the historical data can serve to infer relationships between marketing stimuli and responses. In some cases, the historical data comes from online marketing channels and is comprised of individual user-level data, where a direct cause-effect relationship between stimuli and responses can be verified. However, offline marketing channels such as television advertising are of a nature such that indirect measurements are used when developing models used in media spend optimization. For example, stimuli are described as an aggregate (e.g., TV spots on “Prime Time News”, Monday, Wednesday and Friday) that merely provide a description of an event or events as a time-series of marketing stimuli (e.g., weekly television advertising spends). Responses are also measured and/or presented in aggregate (e.g., weekly unit sales reports provided by the telephone sales center). Correlations, and in some cases causality and inferences, between stimuli and responses can be determined via statistical methods.

As shown in FIG. 1A, a set of stimuli 162₁ can be presented to an audience 164₁ comprising a set of users 103. For example, the stimuli 162₁ might be part of a marketing campaign developed by a marketing manager (e.g., manager 104₁) to reach the audience 164₁ with the objective to generate user conversions (e.g., sales of a certain product) and/or user advancement from a certain engagement state (e.g., no brand awareness) to another engagement state (e.g., brand awareness). The stimuli 162₁ can be delivered to the audience 164₁ through various media channels that can comprise digital or online media channels (e.g., online display, online search, paid social media, email, etc. The media channels can further comprise non-digital or offline media channels (e.g., TV, radio, print, etc.). The audience 164₁ is exposed to each stimulation comprising the stimuli 162₁ through a set of touchpoints 167 characterized by certain respective touchpoint attributes.

Various instances of user interactions 163₁ can further be received through other media channels that can comprise online and offline media channels. In some cases, the information indicating a particular response to the stimuli 162₁ can be included in the touchpoint attribute data associated with the instance of the touchpoints 167 to which the user is responding. Such response data can be stored as sets of touchpoint attributes 134 in touchpoint data 124. In other cases, certain instances of user interactions 163 might not be in response to stimuli 162₁, yet facilitate certain knowledge of user behavior and/or user attributes. Such user profile data can be stored as sets of user profile attributes 135 in user profile data 125. The portion of stimuli 162₁ delivered through online media channels can be received by the users 103 comprising audience 164₁ at various instances of user devices (e.g., mobile phone, laptop computer, desktop computer, tablet, etc.). Further, the portion of user interactions 163₁ detected through digital media channels can also be invoked by the users 103 comprising audience 164₁ using such devices.

As further shown, a set of stimulus data records 172, and a set of touchpoint data records 174 from the user interactivity data 165, can be received over a network (e.g., Internet 160₁ and Internet 160₂, respectively) to be used to generate a touchpoint attribution predictive model 190₁. The touchpoint attribution predictive model 190₁ can be used to estimate the effectiveness of each stimulus in a certain marketing campaign by attributing credit (e.g., contribution value) to the various stimuli for influencing the desired objective of the campaign. The touchpoint attribution predictive model 190₁ can be formed using any machine learning techniques. For example, and as shown, a learning model 192 can be formed to predict a particular response from a particular stimulus. One technique to train the learning model 192 uses a simulator 193 and a model validator 194, as shown. The simulator 193 can provide various subsets of the stimulus data records 172 to the learning model 192 to generate predicted responses that can be compared by the model validator 194 to the expected responses from touchpoint data records 174 to adjust the learning model 192 such that a true attribution of response credit to a given stimulus (e.g., touchpoint), stimulus attribute (e.g., touchpoint attribute), and/or set of stimuli (e.g., media channel) can be established.

Various techniques might be implemented in the learning model 192 to address various attribution biases (e.g., channel saturation, “last click” attribution, etc.). A simulated model 196 can further serve to capture the full range of stimuli variations to facilitate response predictions and/or attribution estimates for various stimuli scenarios. Such techniques can also serve to establish response and performance limits. When formed, the touchpoint attribution predictive model 190₁ can be described in part by certain model parameters (e.g., input variables, output variables, equations, equation coefficients, mapping relationships, limits, constraints, etc.) comprising the touchpoint attribution predictive model parameters 182.

A marketing manager (e.g., manager 104₁) and/or third-party marketing consultant might want to use the touchpoint attribution capabilities of the touchpoint attribution predictive model 190₁ to define a media spend plan 198 (e.g., comprising certain apportionments of stimuli 162₁) that most effectively contributes to desired responses from the audience 164₁ for a given marketing campaign. For example, a media planning application 105 can be provided to an application user (e.g., manager 104₁) for operation on a management interface device 132₁ (e.g., laptop computer) to facilitate such media spend planning. The manager 104₁ might use a set of touchpoint contribution values 138 associated with a single state transition for all the users 103 in audience 164₁ to develop an instance of the media spend plan 198.

As previously discussed, the marketing manager might further want to apply the one or more user engagement states to the touchpoint attributions used to determine an optimized instance of the media spend plan 198 that has certain biases removed (e.g., user propensity biases). In one or more embodiments, the herein disclosed techniques facilitate such media spend planning by segmenting a media campaign based on certain engagement states and determining a set of touchpoint attributions for each segment using a segmented attribution engine 144₁. Specifically, the segmented attribution engine determines a set of media campaign segments 184₁ corresponding to various engagement states (e.g., no engagement, brand awareness, product interest, conversion, etc.). A segment's corresponding engagement states can be based on certain instances of the touchpoint attributes 134 (e.g., impression event, click event, user ID, etc.)and/or on certain instances of the user profile attributes 135 (e.g., male, female, in-market/auto, etc.). Other associations to engagement states are possible. Further, the segment attributes (e.g., engagement states) can be established by the manager 104₁ and/or derived from the touchpoint attribution predictive model 190₁ and/or determined by other techniques. A set of segment touchpoint data records 186 corresponding to a given segment can be selected by the segmented attribution engine 144₁ to be applied to the touchpoint attribution predictive model parameters 182 (e.g., representing the touchpoint attribution predictive model 190₁) to generate a set of segmented touchpoint contribution values 188₁. In some cases, the segmented touchpoint contribution values 188₁ can characterize a measure of the influence that can be attributed to a given touchpoint, touchpoint attribute, and/or group of touchpoints (e.g., associated with the segment touchpoint data records 186) in transitioning one or more of the users 103 from one engagement state to another engagement state associated with the segment.

Such techniques for determining marketing touchpoint attributions in a segmented media campaign disclosed herein address the issues with legacy approaches, Such techniques can provide instances of the segmented touchpoint contribution values 188₁ that enable the marketing manager (e.g., manager 104₁) to determine a set of media spend apportionments that can more effectively (e.g., as compared to using the touchpoint contribution values 138 for a single state conversion) improve the response of users associated with a particular engagement state. An environment for implementing determining marketing touchpoint attributions in a segmented media campaign is discussed in FIG. 1B.

FIG. 1B depicts an environment 1B00 in which embodiments of the present disclosure can operate. As an option, one or more instances of environment 1B00 or any aspect thereof ay be implemented in the context of the architecture and functionality of the embodiments described herein. Also, the environment 1B00 or any aspect thereof may be implemented in any desired environment.

As shown in FIG. 1B, the environment 1B00 comprises various computing systems (e.g., servers and devices) interconnected by a network 108, The network 108 can comprise any combination of a wide area network (e.g., WAN), local area network (e.g., LAN), cellular network, wireless LAN (e.g., WLAN), or any such means for enabling communication of computing systems. The network 108 can also be referred to as the Internet. More specifically, environment 1B00 comprises at least one instance of a measurement server 130₁, at least one instance of an apportionment server 140₁, at least one instance of an ad server 106, at least one instance of a data management server 107, at least one instance of a management interface device 132₂ (e.g., operated by marketing manager represented by the manager 104₁), and a set of databases 120 (e.g., content 122, ads 123, touchpoint data 124, user profile data 125, attribution data 126, planning data 127, model data 128, etc.). The servers and devices shown in environment 11300 can represent any single computing system with dedicated hardware and software, multiple computing systems clustered together (e.g., a server farm, a host farm, etc.), a portion of shared resources on one or more computing systems (e.g., a virtual server), or any combination thereof. Further, the network 108 includes signals comprising data and commands exchanged by and among the aforementioned computing devices and/or by and among any intermediate hardware devices used to transmit the signals. In one or more embodiments, the server 106 can represent an entity (e.g., campaign execution provider) in an online advertising ecosystem that might facilitate the deploying of the stimuli associated with a marketing campaign and/or media spend plan based on the segmented touchpoint contribution values generated according to the herein disclosed techniques.

The environment 1B00 further comprises at least one instance of a user device 102₁ that can represent one of a variety of other computing devices (e.g., a smart phone 102₂, a tablet 102₃, a wearable 102₄, a laptop 102₅, a workstation 102₆, etc.) having software (e.g., a browser, mobile application, etc. and hardware (e.g., a graphics processing unit, display, monitor, etc. capable of processing and displaying information (e.g., web page, graphical user interface, etc.) on a display. The user device 102₂ can further communicate information (e.g., web page request, user activity, electronic tiles, computer files, etc.) over the network 108. The user device 102₁ can be operated by a user 103_{N}. Other users (e.g., user 103₂) with or without a corresponding user device can comprise the audience 164₂.

The users comprising the audience 164₂ can experience a plurality of content (e.g., content 122) provided by a plurality of content providers through any of a plurality of channels (e.g., online display, TV, radio, print, etc.). For example, a certain channel may provide any number of touchpoints (e.g., online display ads, paid search results, etc.) that comprise stimuli for the respective channel. Such touchpoints can be configured to have various attributes so as to reach a certain portion of the audience. Specifically, as shown, the ad server 106 can deliver certain advertising stimuli (e.g., see message 112₁, message 112₂, and message 112_{N}) to the audience 1642 through certain media channels (e.g., see channel1 110₁, channel2 110₂, and channelN 110_{N}, respectively) according to one or more marketing campaigns. Strictly as an example, the ad server 106 can select a particular advertisement from the corpus of ads 123 (e.g., creative provided by an advertiser) and can generate an impression (e.g., content plus the advertisement), which can serve as a touchpoint to be presented to targeted users (e.g., individual users within the audience 164₂) on their respective user devices.

Certain users in the audience 164₂ can interact with the stimuli (e.g., see operation 114₁, operation 114₂, and operation 114_{N}) to produce responses that can be detected by the data management server 107 and/or another component in the online advertising ecosystem. For example, the data management server 107 can receive touchpoint data (e.g., comprising touchpoint attributes associated with the stimuli and/or responses from the audience 164₂ over the network 108 (e.g., see message 116₁, message 116₂, and message 116_{N}). The data management server might further receive from the users in the audience 164₂ instances of user data from various online and offline user interactions activity (e.g., see message 118₁, message 118₂, and message 118_{N}). For example, such user data might include user log data (e.g., HTTP activity, cookies, etc.), user interactions not related to the subject marketing campaign, and/or other user data. In some cases, the data management server 107 might aggregate and/or analyze the user data to produce sets of user profile data (e.g., comprising user profile attributes) (e.g., see operation 119₁, operation 119₂, and operation 119_{N}). The collected touchpoint data and/or user profile data can be stored in the touchpoint data 124 and/or user profile data 125, respectively, which in turn can be made accessible by the measurement server 130 and/or the apportionment server 140₁.

Operations performed by the measurement server 130₁ and the apportionment server 140₁ can vary widely by embodiment. As shown, in one or more embodiments, the apportionment server 140₁ can include an instance of the segmented attribution engine 144₂. In one or more embodiments, the apportionment server 140₁ can further generate and store various attribution data (e.g., segmented touchpoint contribution values, touchpoint contribution values, etc.) in a database or other dataset (e.g., see attribution data 126). In some cases, the apportionment server 140₁ can also collect and store various planning data (e.g., apportionment plans, marketing budgets, etc.) in a database or other dataset (e.g., see planning data 127). In one or more embodiments, the measurement server 130₁ can further generate and store data (e.g., model parameters) various models (e.g., touchpoint attribution predictive model, etc.) in a database or other dataset (e.g., model data 128). Several partitioning possibilities of the components of environment 1B00 are discussed infra.

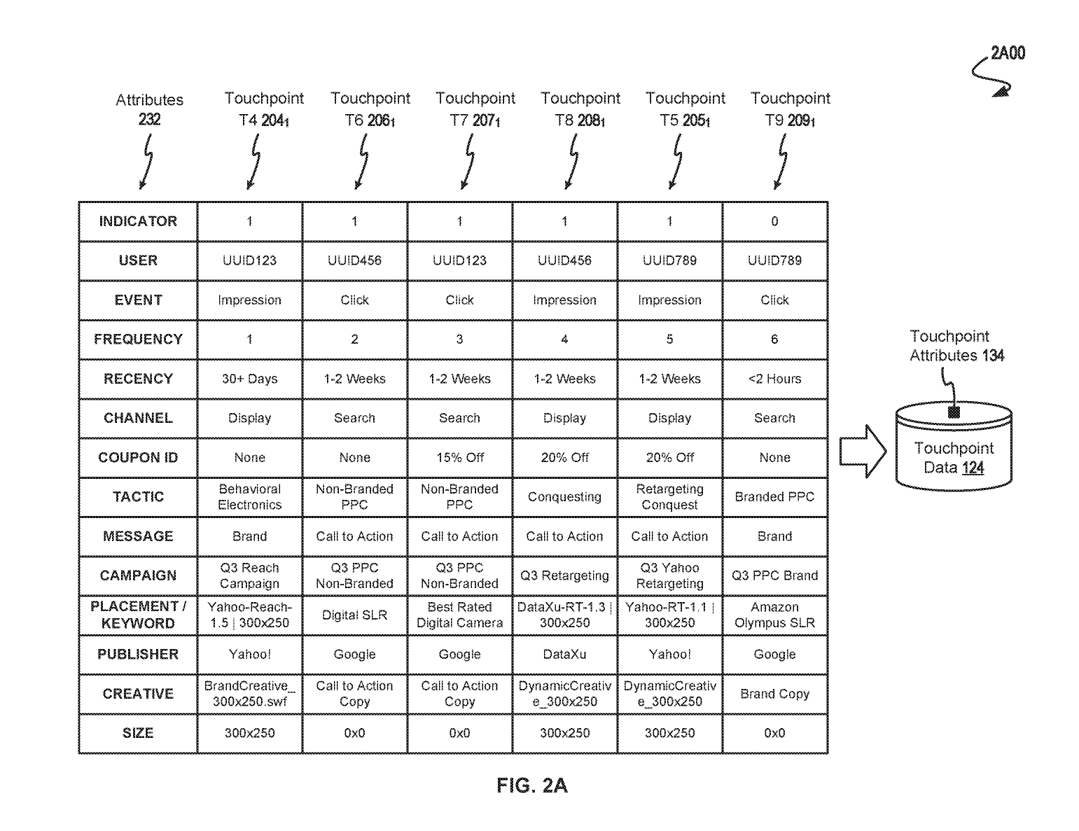

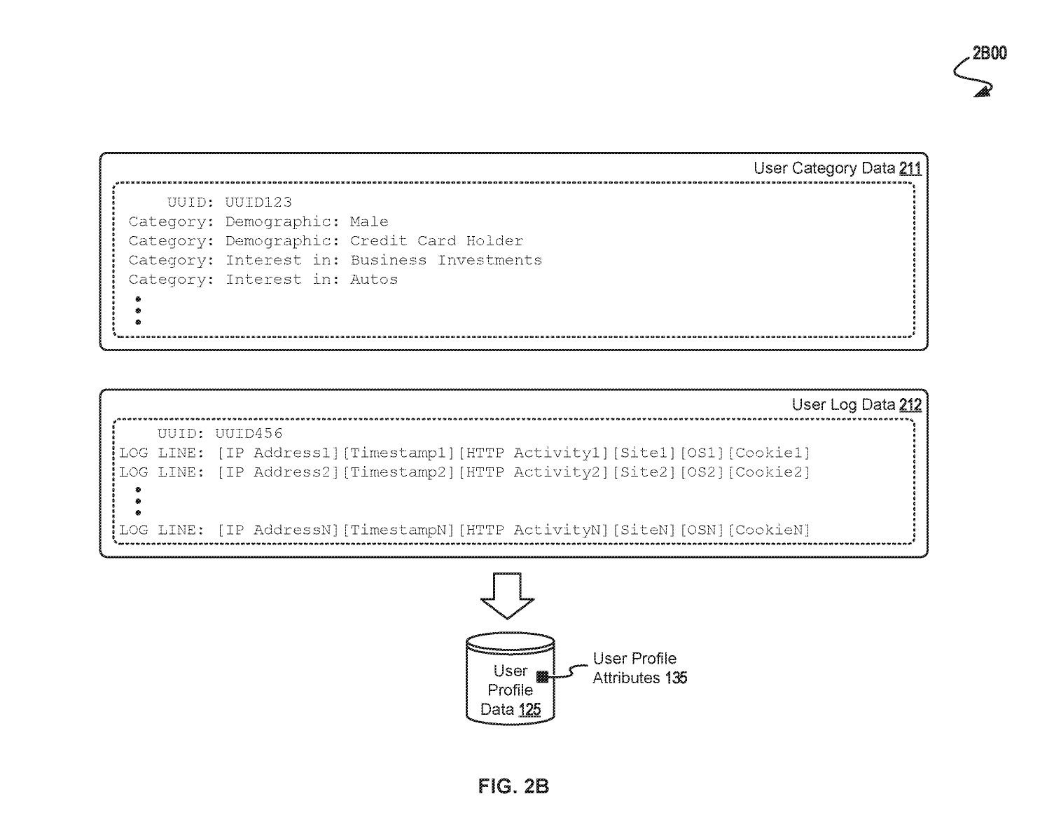

FIG. 2A is a touchpoint attribute chart 2A00 showing sample attributes associated with touchpoints of a media campaign. As an option, one or more instances of touchpoint attribute chart 2A00 or any aspect thereof may be implemented in the context of the architecture and functionality of the embodiments described herein. Also, the touchpoint attribute chart 2A00 or any aspect thereof may be implemented in any desired environment

As discussed herein, a touchpoint can be any occurrence where a user interacts with any aspect of a media campaign (e.g., display ad, keyword search, TV ad, etc.). Recording the various stimulus and response touchpoints associated with a marketing campaign can enable certain key performance indicators (KPIs) for the campaign to be determined at various measurement levels. For example, touchpoint information (e.g., touchpoint attributes 134 shown in FIG. 1A) might be captured in the stimulus data records, user interactivity data, the touchpoint data records, the segment touchpoint data records, and/or other data records for use by the herein disclosed techniques. Yet, some touchpoints are more readily observed than other touchpoints. Specifically, touchpoints in non-digital media channels might be not be observable at a user level and/or an individual transaction level such that summary and/or aggregate responses in non-digital channels are provided. In comparison, touchpoints in digital media channels can be captured real-time at a user level (e.g., using Internet technology). The attributes of such touchpoints in digital media channels can be structured as depicted in the touchpoint attribute chart 2A00.

Specifically, the touchpoint attribute chart 2A00 shows a plurality of touchpoints touchpoint T4 204₁, touchpoint T6 206₁, touchpoint T7 207₁, touchpoint T8 208₁, touchpoint T5 205₁, and touchpoint T9 209₁) that might be collected and stored (e.g., in touchpoint data 124) for various analyses (e.g., at a measurement server, an apportionment server, etc.). The example dataset of touchpoint attribute chart 2A00 maps the various touchpoints with a plurality of attributes 232 associated with respective touchpoints (e.g., touchpoint attributes 134). For example, the attribute “Channel” identifies the type of channel (e.g., “Display”, “Search”) that delivers the touchpoint, the attribute “Message” identifies the type of message (e.g., “Brand”, “Call to Action”) delivered in the touchpoint, and so on.

More specifically, as indicated by the “Event” attribute, touchpoint T4 204₁ was an “Impression” presented to the user, while touchpoint T6 206₁ corresponds to an item (e.g., “Call to Action” for “Digital SLR”) that the user responded to with a “Click” event. Also, as represented by the “Indicator” attribute, touchpoint T4 204₁ was presented (as indicated by a “1”) in the time window specified by the “Recency” attribute (e.g., “30+ Days”), while touchpoint T9 209₁ was not presented (e.g., as indicated by a “0”) in the time window specified by the “Recency” attribute (e.g., “<2 hours”). For example, the “Indicator” can be used to distinguish the touchpoints actually exposed to a user as compared to planned touchpoint stimulus. In some cases, the “Indicator” can be used to identify responses to a given touchpoint (e.g., a “1” indicates the user responded with a click, download, etc.). Further, as indicated by the “User” attribute, touchpoint T4 204₁ was presented to a user identified as “UUID123”, while touchpoint T6 206₁ was presented to a user identified as “UUID456”. The remaining information in the touchpoint attribute chart 2A00 identifies other attribute values for the plurality of touchpoints.

In many of the systems and techniques discussed herein, the attributes 232. shown for the representative touchpoints in the touchpoint attribute chart 2A00 can serve to determine, in part, the segmentation of a media campaign. Specifically, the media campaign can be segmented according to engagement states associated with the “Event” and “User” attributes. For example, a segment might be defined by a certain set of users transitioning from a first engagement state associated with a first touchpoint interactivity event (e.g., product ad impression “Event”) to a second engagement state associated with a second touchpoint interactivity event (e.g., product purchase button click “Event”). As another example, the “User” touchpoint attribute (e.g., UUID 123) might have a relationship to various user profile attributes that characterize certain segments of users (e.g., for the marketing campaign) based on one or more user categories (e.g., male, female, interest in autos, etc.). FIG. 2B describes examples of such user profile data.

FIG. 2B is a diagram depicting data structures 2B00 used to associate user profile information with touchpoints of a media campaign. As an option, one or more instances of data structures 2B00 or any aspect thereof may be implemented in the context of the architecture and functionality of the embodiments described herein. Also, data structures 2B00 or any aspect thereof may be implemented in any desired environment.

The data structures 2B00 shown in FIG. 2B are examples of the user profile data that can be associated with media touchpoints the touchpoint “User” attribute). Such user profile data might be collected and/or generated by a data management platform for use in systems for determining marketing touchpoint attributions in a segmented media campaign. Specifically, user category data 211 comprises a user ID (e.g., UUID123) and a plurality of categories (e.g., Demographic: Male, interest in: Autos, etc.) associated with the user, Also, user log data 212 comprises a user ID (e.g., UUID456) and a plurality of log lines (e.g., LOG LINE: . . . , etc.) associated with the user. A log line (e.g., generated from on-line browsing) comprises various signals (e.g., IP address, timestamp, site, operating system or OS, cookie reference, etc.) that can be used to describe the behaviors and activity of a given user.

In some embodiments, media campaign segments can be associated with respective audience segments characterized, in part, by user profile data user profile data and/or user profile attributes (e.g., user profile attributes 135) such as included in data structures 2B00. For example, referring to FIG. 2A, the data measured and collected for touchpoint T4 204 and touchpoint T7 207₁ indicate that user “UUID123” received and responded to the shown touchpoints within a certain time window (e.g., as shown by the “Indicator” attribute). As shown in user category data 211, user “UUID123” is “Male”. Analysis of other touchpoint data (e.g., not shown in FIG. 2A) might reveal that other “Male” users also received and responded to touchpoint T4 204₁ and touchpoint T7 207₁ within the time window. Given these results, a marketing manager might segment a media campaign between a “Male” audience segment and a “Female” audience segment, and have different media spend apportionments based on the touchpoint attributions for the respective segments.

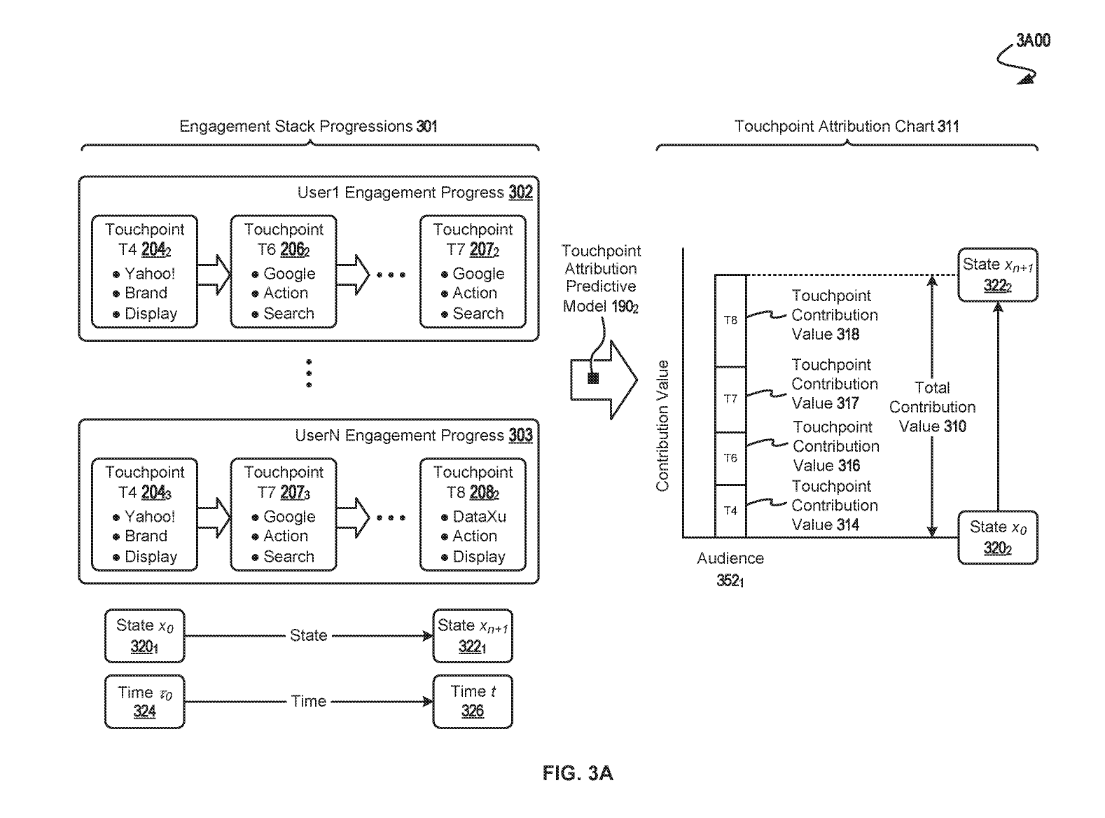

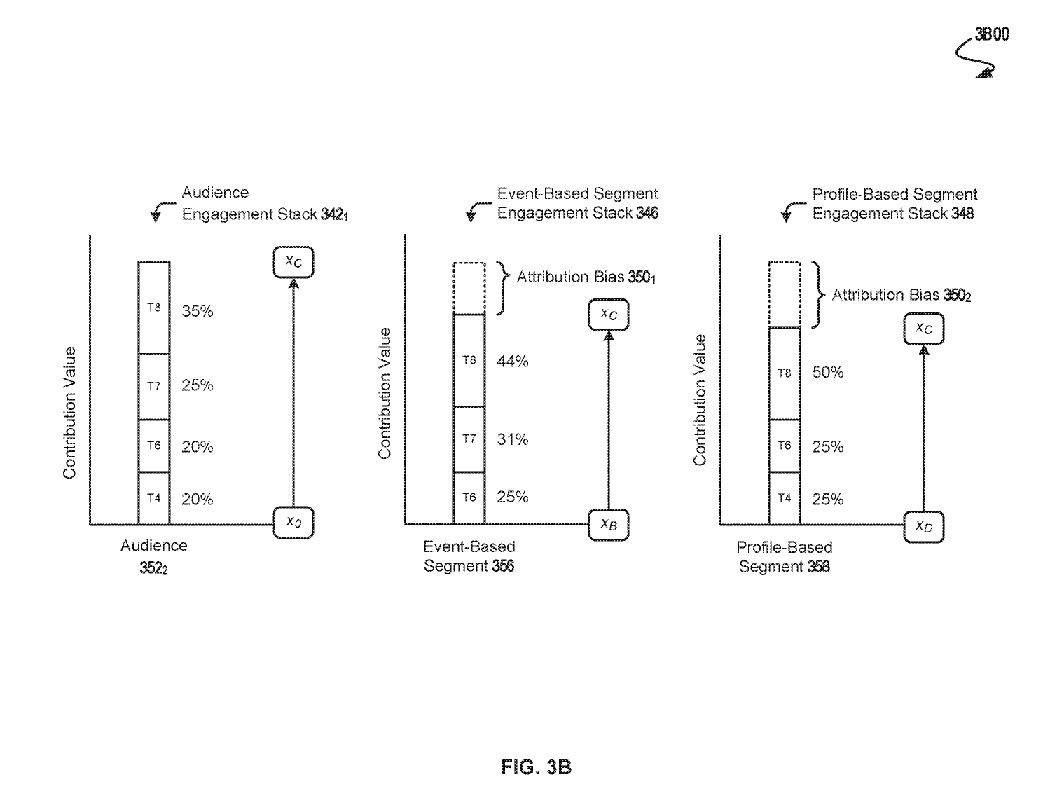

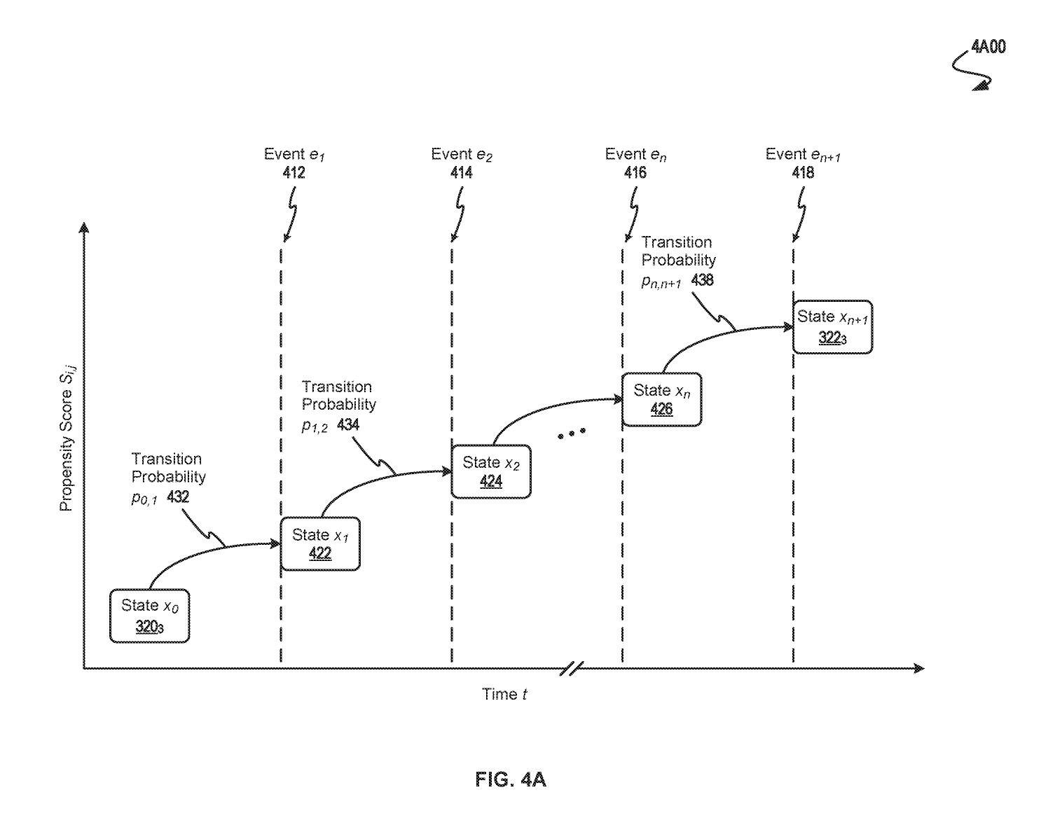

A measurable relationship between one or more touchpoints and a progression through engagement and/or readiness states towards a target state is possible. In some cases, the relationship between touchpoints is deterministic (e.g., based on UUID, etc.). In other cases, the relationship between touchpoints can be probabilistic (e.g., a likelihood that two or more touchpoints are related). Such a collection of touchpoints contributing to reaching the target state (e.g., conversion, brand engagement, etc.) can be called an engagement stack. indeed, such engagements stacks can be applied to a touchpoint attribution predictive model to determine the attribution (e.g., contribution values) of each touchpoint associated with certain desired responses such as advancing to a certain target engagement state characterized by some touchpoint interaction event. When analyzing the impact of touchpoints on a user's engagement progression and possible realization of the target engagement state (e.g., execution of the target touchpoint interaction event), a time-based progression view of the touchpoints and a contribution value of the touchpoints (e.g., touchpoint attribution) can be considered as shown in FIG. 3A.

FIG. 3A illustrates a touchpoint attribution technique 3A00, according to some embodiments. As an option, one or more instances of touchpoint attribution technique 3A00 or any aspect thereof may be implemented in the context of the architecture and functionality of the embodiments described herein. Also, the touchpoint attribution technique 3A00 or any aspect thereof may be implemented in any desired environment.

The touchpoint attribution technique 3A00 illustrates a set of engagement stack progressions 301 that is transformed by the touchpoint attribution predictive model 190₂ to a touchpoint attribution chart 311. Specifically, the engagement stack progressions 301 depicts progressions through various touchpoints experienced by one or more users. More specifically, a User1 engagement progress 302 and a UserN engagement progress 303 are shown as representative of an audience 352₁ (e.g., comprising User1 to UserN). The User1 engagement progress 302 and the UserN engagement progress 303 represent the user's progress from a state x₀ 320₁ to a state xₙ₊₁ 322₁ over a time τ₀ 324 to a time t 326. For example, the state x₀ 320₁ can represent an initial engagement state (e.g., no engagement) and the state xₙ₊₁ 322₁ can represent a final engagement state (e.g., conversion, brand engagement event, etc.). Further, the time τ₀ 324 to the time t 326 can represent a measurement time window for performing touchpoint attribution analyses.

As shown in User1 engagement progress 302, User1 might experience a touchpoint T4 204₂ comprising a branding display creative published by Yahoo!. At some later moment, User1 might experience a touchpoint T6 206₂ comprising Google search results (e.g., search keyword “Digital SLR”) prompting a call to action. At yet another moment later in time, User1 might experience a touchpoint T7 207? comprising Google search results (e.g., search keyword “Best Rated Digital Camera”) also prompting a call to action. Also as shown in UserN engagement progress 303, UserN might experience a touchpoint T4 204₃ having the same attributes as touchpoint T4 204₂. At some later moment, UserN might experience a touchpoint T7 207₃ having the same attributes as touchpoint T7 207₂. At yet another moment later in time, UserN might experience a touchpoint T8 208₂ comprising a call-to-action display creative published by DataXu. Any number of timestamped occurrences of these touchpoints and/or additional information pertaining to the touchpoints and/or user responses to the touchpoints captured in touchpoint attributes), can be received over the network in real time for use in generating the touchpoint attribution predictive model 190₂ and/or generating the touchpoint attribution chart 311.

Specifically, the touchpoint attribution chart 311 shows the touchpoint contribution values (e.g., touchpoint contribution value 314, touchpoint contribution value 316, touchpoint contribution value 317, and touchpoint contribution value 318) of all instances of the respective touchpoints (e.g., touchpoint T4, touchpoint T6, touchpoint T7, and touchpoint T8, respectively) aggregated over the audience 352₁. The overall contribution value of the touchpoints pertaining to the audience 352₁ is defined by a total contribution value 310. Various techniques can determine the contribution value from the available touchpoint data. As shown, the contribution values indicate a measure of the influence (e.g., lift, contribution, conversion credit, etc.) attributed to a respective touchpoint in transitioning a user in the audience 352₁ from state x₀ 320₂ to state x₊₁ 322₂.

As shown, legacy approaches might consider the total contribution value 310 and/or the touchpoint contribution values (e.g., touchpoint contribution value 314, touchpoint contribution value 316, touchpoint contribution value 317, and touchpoint contribution value 318) associated with all the users (e.g., N users) comprising the audience 352₁. Further, such approaches might only consider transitions from a no engagement state (e.g., state x₀ 320₂) to a conversion state (e.g., state xₙ₊₁ 322₂). In such cases, one or more biases might exist in the touchpoint contribution values and/or total contribution value due to inherent propensities of certain users in audience 352₁ to transition from state x₀ 320₂ to state xₙ₊₁ 322₂ and/or any intermediate engagement state. Such attribution biases are discussed further as pertains to FIG. 3B.

FIG. 38 depicts an attribution bias removal technique 3B00 facilitated by systems for determining marketing touchpoint attributions in a segmented media campaign. As an option, one or more instances of attribution bias removal technique 3B00 or any aspect thereof may be implemented in the context of the architecture and functionality of the embodiments described herein. Also, the attribution bias removal technique 3B00 or any aspect thereof may be implemented in any desired environment.

The attribution bias removal technique 3B00 illustrates the attribution bias that can be present in certain legacy approaches. Specifically, approaches that consider only an entire audience and/or only a single transition from a no engagement state to a conversion engagement state when determining touchpoint attribution values can have attribution biases due to inherent propensities of certain users in the audience to transition from one engagement state to another engagement state, including any intermediate engagement states. Such biases can adversely impact media spend decisions and/or plans for certain aspects of a marketing campaign (e.g., for retargeting).

As shown, FIG. 3B depicts an audience engagement stack 342₁ based on the touchpoint attribution chart 311 in FIG. 3A. The relative touchpoint attribution (e.g., percent of total contribution value of each touchpoint contribution value) among touchpoints T4, T6, T7, and T8 for a transition from no engagement state x₀ to conversion engagement state x_{C} for the audience 352₂ (e.g., N users) is 20%, 20%, 25%, and 35%, respectively. A marketing manager might use the percentages to al locate a media spend budget for a given marketing campaign. in some cases, the percentages determined for the audience 352₂ might result in an overspending scenario on some media and/or an underspending scenario on other media.

Specifically, a portion of the audience 352₂ might have a certain propensity to convert -presented by an engagement state x_{B}. For example, certain users might have experienced certain touchpoint events related to and/or unrelated to a given marketing campaign (e.g., signing up for a rewards program with brand BB) that can be correlated to a propensity to convert associated with the engagement state x_{B}. In such cases, the herein disclosed techniques can facilitate the generation of segmented touchpoint contribution values comprising an event-based segment engagement stack 346 for an event-based segment 356 (e.g., users at engagement state x_{B}). Specifically, the relative segmented touchpoint attribution for a transition from engagement state x_{B} to conversion engagement state x^{C} for the event-based segment 356 (e.g., portion of the N users in audience 352₂) is 25%, 31%, and 44%, for touchpoints T6, T7, and T8, respectively. As shown, the legacy approach of using the touchpoint attributions in the audience engagement stack to reach the event-based segment 356 can result in an attribution bias 350₁. Specifically, touchpoint T4 from the audience engagement stack is not present in the event-based segment engagement stack 346. For example, touchpoint T4 might be a brand awareness impression for brand BB that has no influence on users who have already signed up for a rewards program with brand BB and are at engagement state x_{B}. In this case, any spending that might have been apportioned to touchpoint T4 can be apportioned to the other touchpoints according to the percentages shown in the event-based segment engagement stack 346.

As another example, a portion of the audience 352₂ might have a certain user profile attribute that would result in a certain propensity to convert. For example, certain users might have been categorized as “Digital Camera Owners” by a data management platform provider. In some cases, such user categories can be correlated to a propensity to convert associated with a certain engagement state x_{D}. The herein disclosed techniques can facilitate the generation of segmented touchpoint contribution values comprising a profile-based segment engagement stack 348 for a profile-based segment 358 (e.g., users in category “Digital Camera Owners”). Specifically, the relative segmented touchpoint attribution for a transition from engagement state x_{D} to conversion engagement state x_{C} for the profile-based segment 358 (e.g., portion of the N users in audience 352₂) is 25%, 25%, and 50%, for touchpoints T4, T6, and T8, respectively. As shown, the legacy approach of using the touchpoint attributions in the audience engagement stack to reach the profile-based segment 358 can result in an attribution bias 350₂. Specifically, touchpoint T7 from the audience engagement stack is not present in the profile-based segment engagement stack 348. For example, touchpoint T7 might be a paid search ad for keyword “Best rated digital camera” that would not apply to the “Digital Camera Owners”. In this case, any spending that might have been apportioned to touchpoint T7 can be apportioned to the other touchpoints according to the percentages shown in the profile-based segment engagement stack 348.

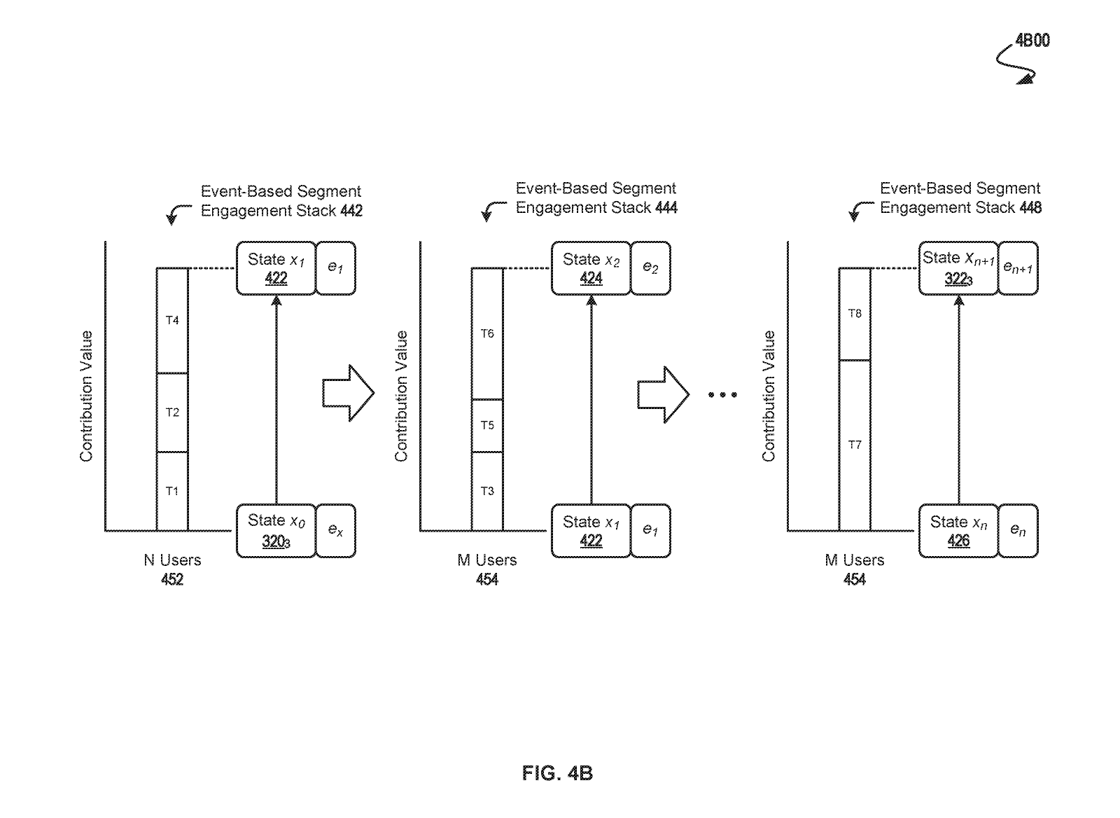

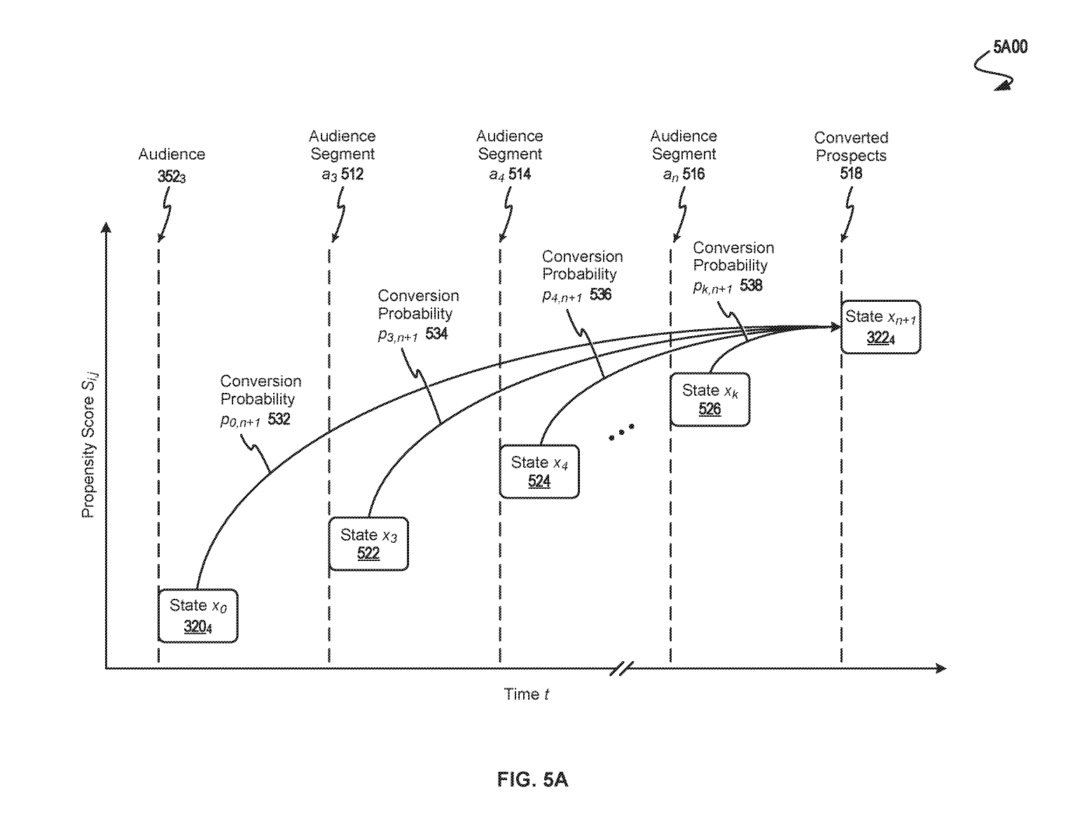

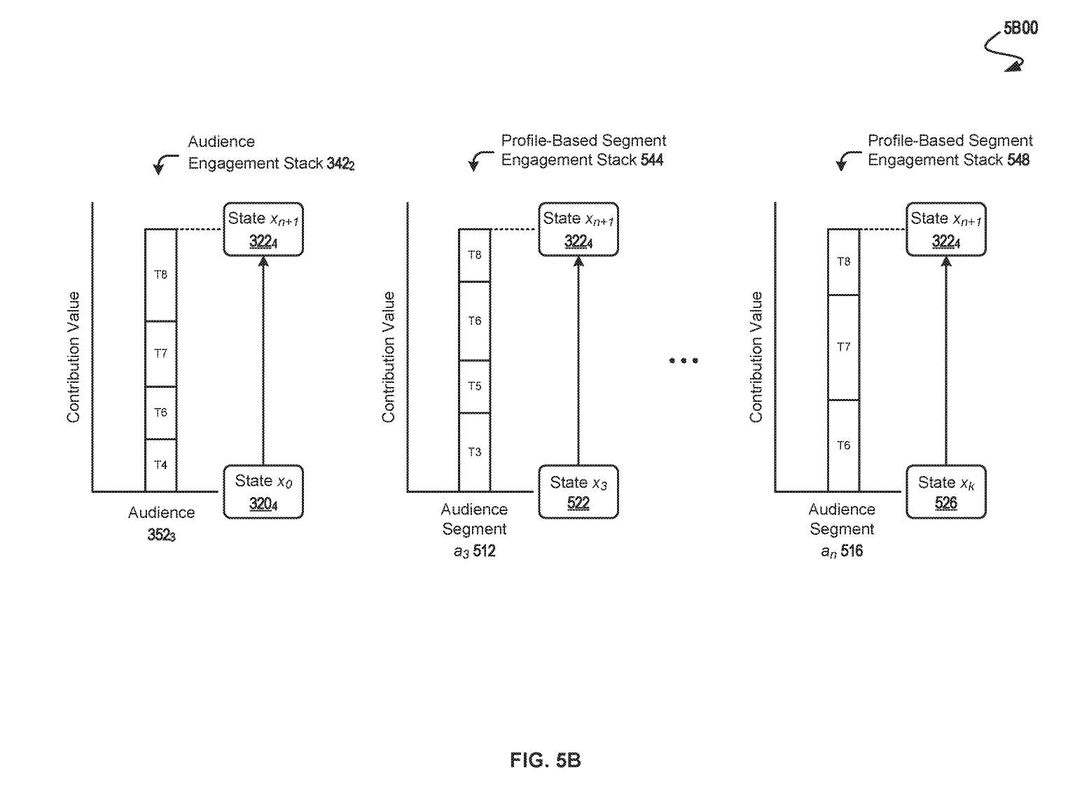

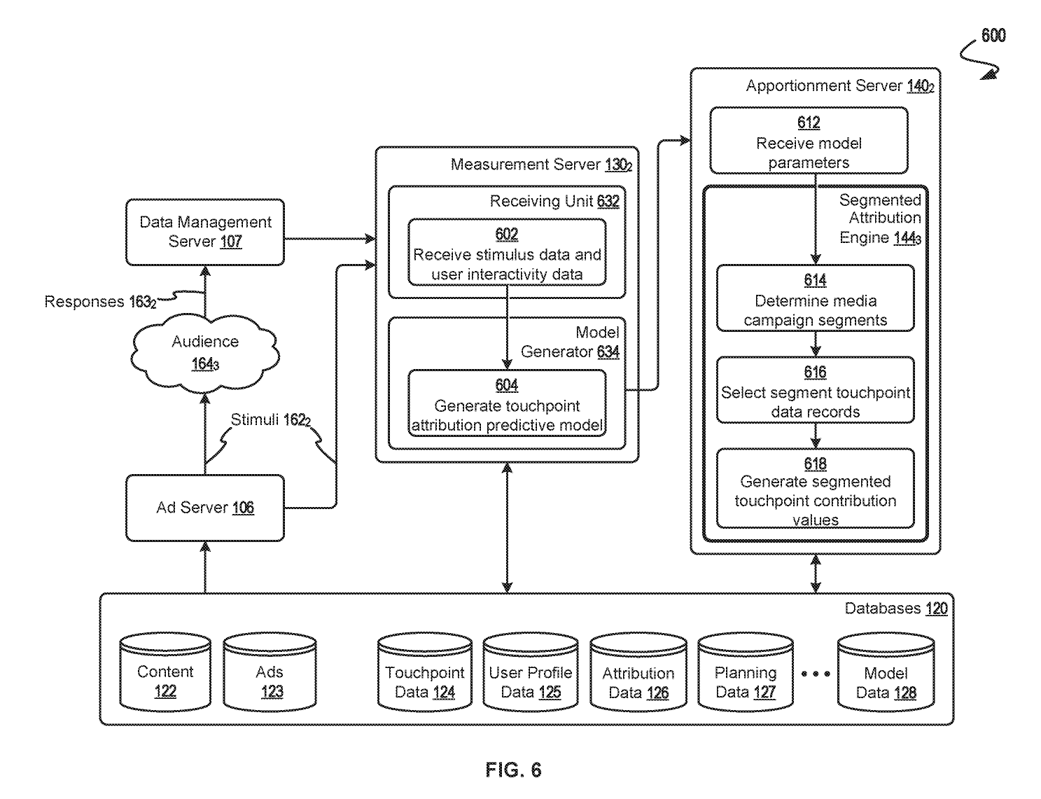

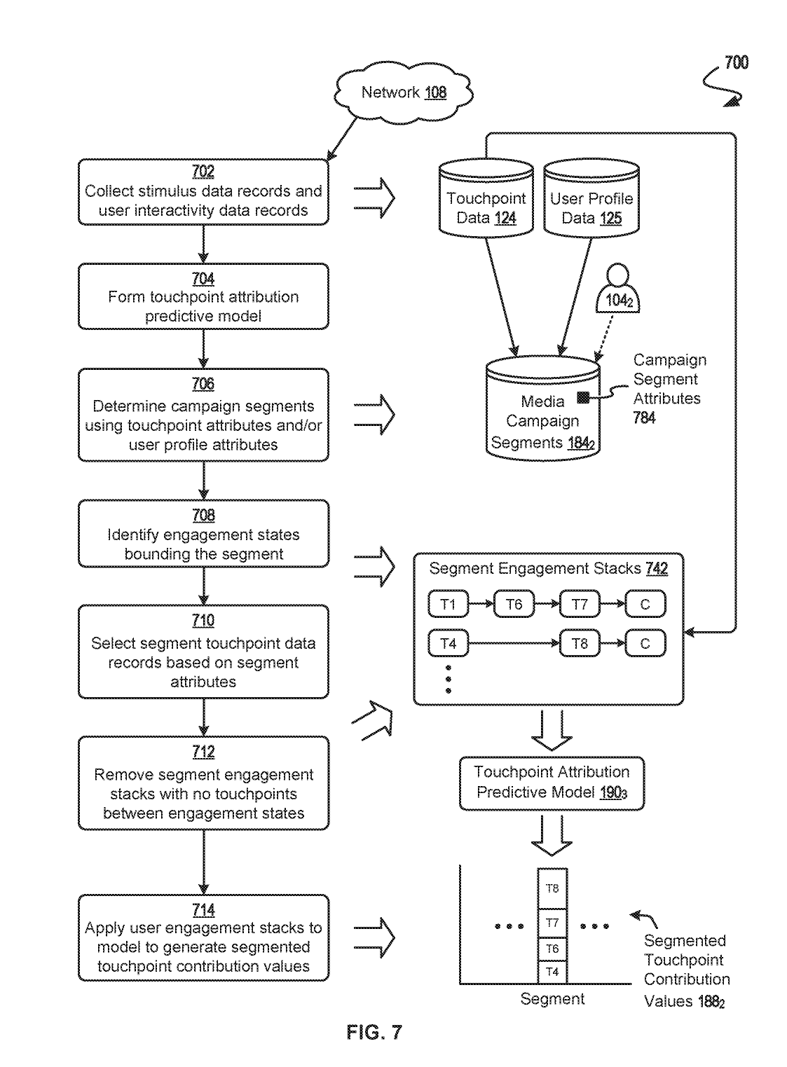

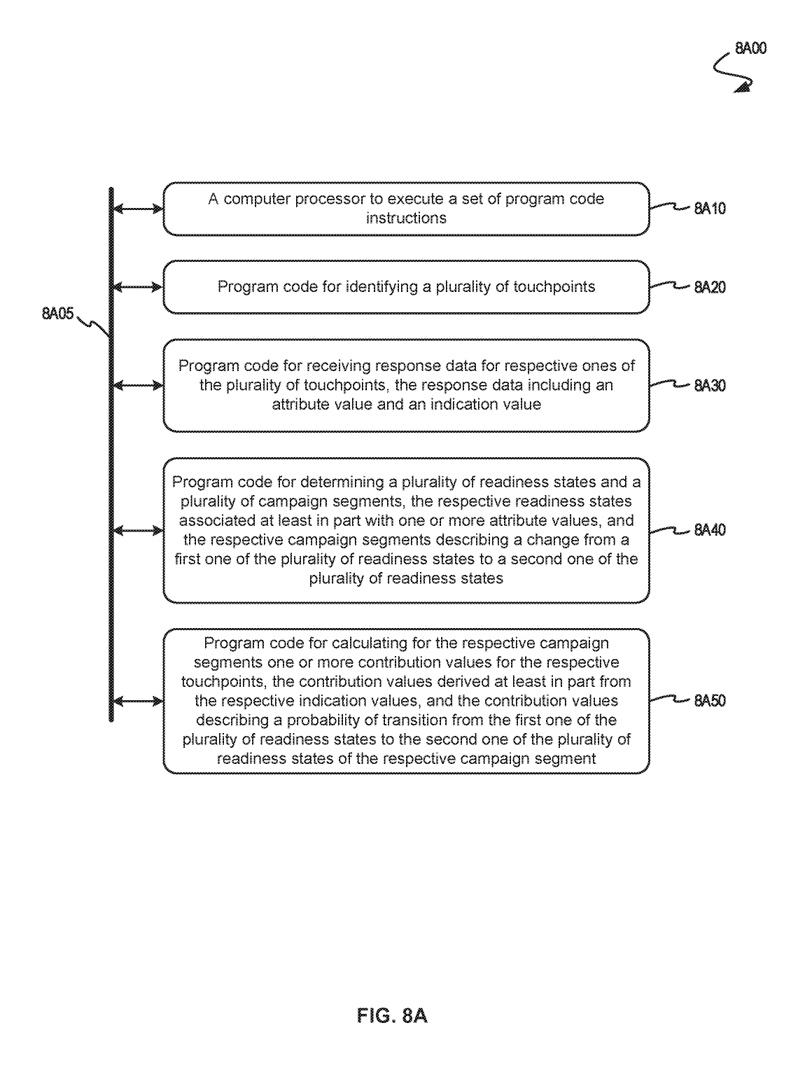

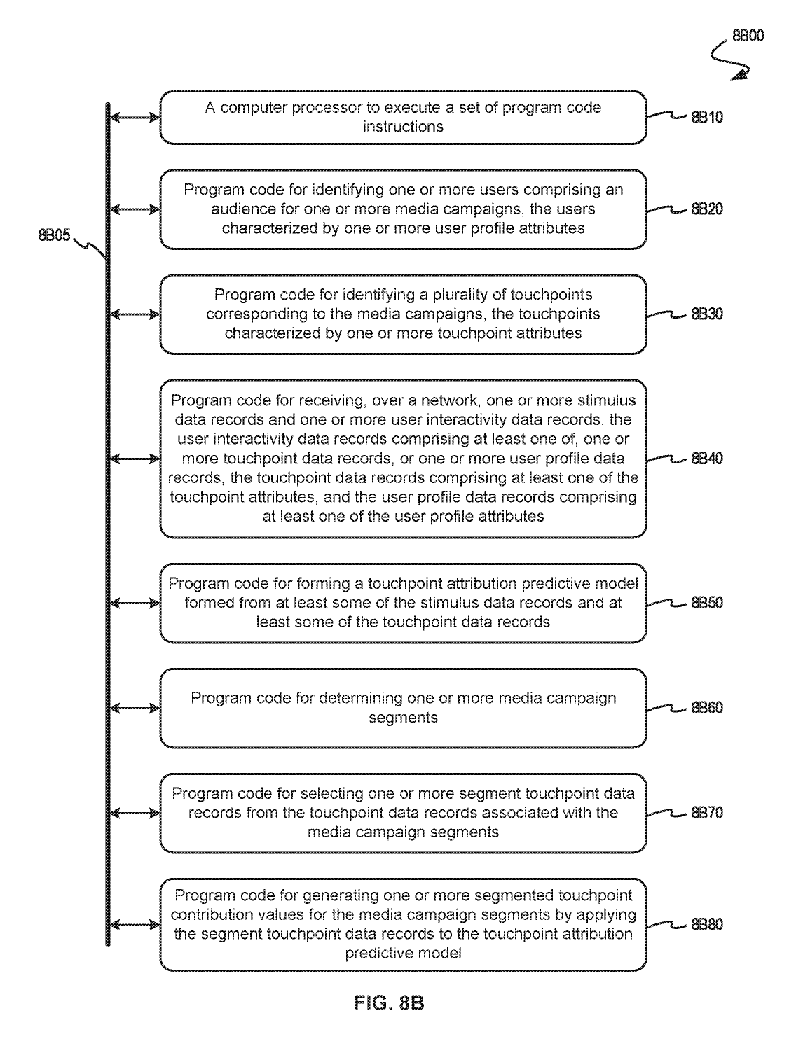

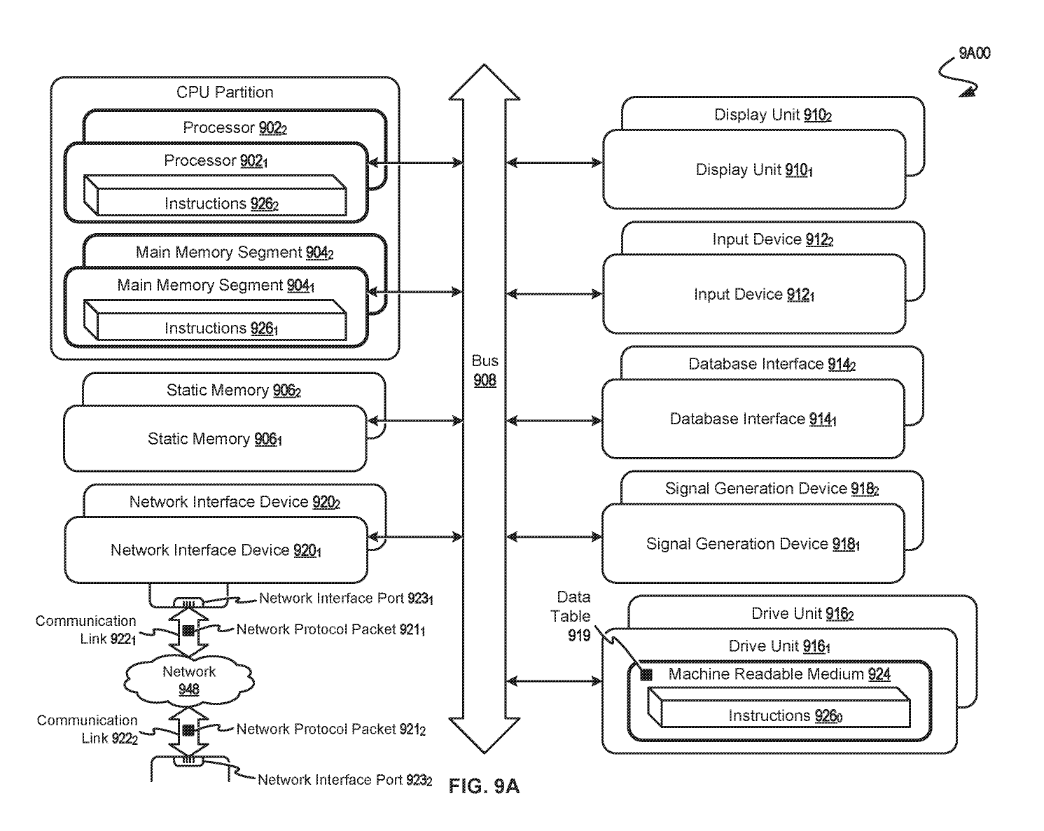

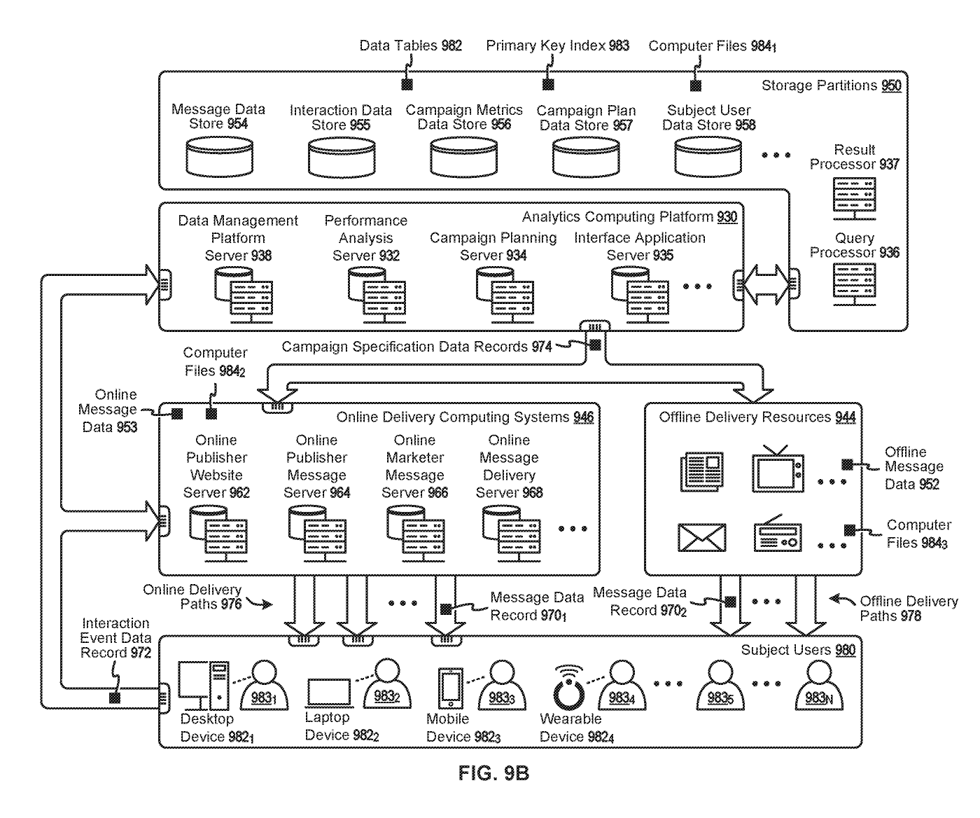

The foregoing attribution biases are addressed by the herein disclosed techniques by segmenting a marketing campaign and generating segmented touchpoint contribution values, Such segmentation and segmented attributions are described in FIG. 4A and FIG. 4B, respectively.

FIG. 4A depicts an engagement state diagram 4A00 showing a segmented user engagement progression and associated events, according to some embodiments. As an option, one or more instances of engagement state diagram 4A00 or any aspect thereof may be implemented in the context of the architecture and functionality of the embodiments described herein.

The engagement state diagram 4A00 depicts various engagement states experienced by a user as the user progresses from a state x₀ 320₃ (e.g., no engagement) towards a state xₙ₊₁ 322₃ (e.g., conversion). Specifically, the engagement state diagram 4A00 shows a plurality of engagement states (e.g., state x₁ 422, state x₂ 424, . . ., and state xₙ 426) between state x₀ 320₃ and state xₙ₊₁ 322₃ over time t. A user's engagement state at time t, or X(t), can be represented by:

X(t) ε{x₀, x₁, x₂, . . . , xₙ, xₙ₊₁} [EQ. 1]

Further, a plurality of events (e.g., event e₁ 412, event e₂ 414, . . . , event eₙ 416, and event eₙ₊₁ 418) can be associated with the respective engagement states (e.g., state x₁ 422, state x₂ 424, . . . , state xₙ 426, and state xₙ₊₁ 322₃, respectively). For example, a touchpoint representing a “Click” event (e.g., event eₙ 416) can be associated with an engagement state just prior to conversion (e.g., state xₙ 426). in some cases, an event can be associated with an engagement state as specified by a marketing manager. In other cases, an event can be associated with an engagement state based on analysis of the available data An event associated with an engagement state at time t, or E(t), can be represented by:

E(t) ε{e₁, e₂, . . . , eₙ, eₙ₊₁} [EQ. 2]

In one or more embodiments, the propensity of reaching a certain engagement state can be codified in a propensity score S. More specifically, the propensity (e.g., of a user and/or group of users) of transitioning to a state xⱼ at a time t from a state xᵢ since time τᵢ can be represented by S_{i,j}(t, τᵢ), where S_{i,j}(t, τᵢ) is a function of the presented touchpoints between time τᵢ and time t. Further, there can be a probability of a transition from a state xᵢ to a state xⱼ (e.g., transition probability p_{0,1} 432, transition probability p_{1,2} 434, and transition probability p_{n,n+1} 438). More specifically, such transition probabilities can be modeled as:

p_{i,j}(t,τᵢ)=p[X(t)=xⱼ|X(t′)=xᵢ]=p[S_{i,j}(t,τᵢ)] [EQ. 3]

where τᵢ≦t′<t.

While a marketing manager might consider only the probability of transitioning from state x₀ 320₃ to state xₙ₊₁ 322₃ (e.g., the transition probability p_{0,n+1}), the marketing manager might further want to know the probability of transitioning between all defined states in order to most effectively optimize media spending in the respective segments to move the audience through the state progression to conversion. Such a cascaded model of segmented touchpoint attributions is described in FIG. 4B.

FIG. 4B depicts an event-based segment attribution technique 4B00 for determining marketing touchpoint attributions in a segmented media campaign, according to some embodiments. As an option, one or more instances of the event-based segment attribution technique 4B00 or any aspect thereof may be implemented in the context of the architecture and functionality of the embodiments described herein.

The event-based segment attribution technique 4B00 shows the relative contribution values of various touchpoints that contributed to transitioning a set of users from a first state associated with a first event to a second state associated with a second event. More specifically, the event-based segment attribution technique 41300 depicts an event-based segment engagement stack 442 (e.g., comprising touchpoints T1, T2 and T4) that contributed to the transitioning N users 452 from the state x₀ 320₃ associated with any event eₓ (e.g., no measurable event) to the state x₁ 422 associated with an event e ₁. At a later time, the N users 452 experienced certain touchpoints (e.g., touchpoints T3, T5 and T6) comprising an event-based segment engagement stack 444 that contributed to transitioning the M users 454 (e.g., where M<N) from the state x₁ 422 associated with the event e₁ to the state x₂ 424 associated with an event e₂. After further state transitions, the M users 454 experienced other touchpoints (e.g., touchpoints T7 and T8) comprising an event-based segment engagement stack 448 that contributed to transitioning all the M users 454 from the state xₙ 426 associated with an event eₙ to the state xₙ₊₁ 322₃ associated with an event eₙ₊₁ (e.g., conversion event).

As shown, by segmenting the campaign into a plurality of engagement state transitions characterized by one or more events (e.g., touchpoint experiences and determining the touchpoint attribution for the respective state transitions, the marketing manager is able to discern that all the M users 454 converted after reaching the state x₂ 424 corresponding to event e₂ (e.g., click on search call to action). The marketing manager might decide to allocate more media spending to moving more of the audience to state x₂ 424, and allocate less spending on touchpoints nearer to conversion (e.g., touchpoints T7 and T8). If the marketing manager only analyzed the overall audience and/or conversion attribution (e.g., see audience engagement stack 342₁ in FIG. 3B), then the marketing manager might allocate too much media spend to touchpoints T7 and T8.

The herein disclosed systems and techniques can further be applied to touchpoint attributions for a set of respective segments associated with various audience segments characterized by one or more user profiles as described in FIG. 5A and FIG. 5B.

FIG. 5A depicts an engagement state diagram 5A00 showing a segmented user engagement progression and associated audience segments. As an option, one or more instances of engagement state diagram 5A00 or any aspect thereof may be implemented in the context of the architecture and functionality of the embodiments described herein.

The engagement state diagram 5A00 depicts various engagement states experienced by a user as the user progresses from the state x₀ 320₄ (e.g., no engagement) towards the state xₙ₊₁ 322₄ (e.g., conversion), Specifically, the engagement state diagram 5A00 shows a plurality of engagement states (e.g., state x₃ 522, state x₄ 524, . . . , and state xₖ 526) between state x₀ 320₄ and state xₙ₊322₄ over time t. A user's engagement state at time t, or X(t), can be represented as shown in equation [EQ. 1]. Further, a plurality of audience segments (e.g., all prospects in an audience 352₃, audience segment a₃ 512, audience segment a₄ 514, . . . , audience segment aₙ 516, and converted prospects 518) can be associated with the respective engagement states state x₀ 320₄, state x₃ 522, state x₄ 524, . . . , state xₖ 526, and state xₙ₊₁ 322₄, respectively).

For example, an audience segment (e.g., audience segment a₃ 512) characterized by a certain user profile demographic (e.g., gender of “Male”) can be associated with a certain state of readiness (e.g., state x₃ 522) using the data, data structures, attributes, and techniques described herein. In one or more embodiments, the user profile attributes (e.g., user UUIDs in a certain category) defining a given audience segment can be related to one or more touchpoint data records using certain touchpoint attributes (e.g., the “User” attribute). In some cases, an audience segment can be associated with an engagement state as specified by a marketing manager. In other cases, an audience segment can be associated with an engagement state based on analysis of the available data. An audience segment associated with an engagement state at time t, or A(t), can be represented by:

A(t)ε{a₁, a₂, . . . , a_{n}} [EQ. 4]

In one or more embodiments, the propensity of reaching a certain state can be codified in a propensity score S. More specifically, the propensity (e.g., of a segment of users) of transitioning to a state xⱼ at a time t from a state xᵢ can be modeled. For example, time τᵢ can be represented in a function such as S_{i,j}(t, τᵢ), where S_{i,j}(t, τᵢ) is a function of the presented touchpoints between time τᵢ and time t. Further, there can be a probability of a transition from a state xᵢ to a conversion state represented by state xₙ₊₁ (e.g., conversion probability p_{0,n+1} 532, conversion probability p_{3,n+1} 534, conversion probability p_{4,n+1} 536, and conversion probability p_{k,n+1} 538). Such conversion probabilities can be modeled as shown in equation [EQ. 3] with j=n+1.

While a marketing manager might consider all users in the audience 352₃ as behaving the same (e.g., having the same propensity to convert, being at the same engagement state, etc.), the marketing manager might further want to know the touchpoints contributing to conversion for various audience segments in order to most effectively optimize media spending when targeting (or -targeting) the respective segments. Such an audience segment attribution model is described in FIG. 5B.

FIG. 5B depicts a profile-based segment attribution technique 5B00 for determining marketing touchpoint attributions in a segmented media campaign, according to some embodiments. As an option, one or more instances of the profile-based segment attribution technique 5B00 or any aspect thereof may be implemented in the context of the architecture and functionality of the embodiments described herein.

The profile-based segment attribution technique 5B00 shows the relative contribution values of various touchpoints that contributed to transitioning a set of users from a first state to a second state. More specifically, the profile-based segment attribution technique 5B00 depicts an instance of the audience engagement stack 342₂ (e.g., comprising touchpoints T4, T6, T7, and T8) that contributed to transitioning the set of all prospects in the audience 352₃ from the state x₀ 320₄ to the state xₙ₊₁ 322₄ (e.g., conversion). Also shown is a profile-based segment engagement stack 544 (e.g., comprising touchpoints T3, T5, T6, and T8) that contributed to transitioning the audience segment a₃ 512 from the state x₃ 522 to the state xₙ₊₁ 322₄ (e.g., conversion). Further shown is a profile-based segment engagement stack 548 (e.g., comprising touchpoints T6, T7, and T8) that contributed to transitioning the audience segment aₙ 516 from the state xₖ 526 to the state xₙ₊₁ 322₄ (e.g., conversion). Other audience segments and respective attributions touchpoint contribution values) are possible.

As shown, by segmenting the campaign into a plurality of audience segments and determining the segmented touchpoint contribution values for the respective audience segments, the marketing manager is able to discern that different audience segments all prospects in the audience 352₃, audience segment a₃ 512, and audience segment aₙ 516) can have different engagement stacks (e.g., audience engagement stack 342₂, profile-based segment engagement stack 544, and profile-based segment engagement stack 548, respectively). In some cases, the engagement stack (e.g., the set of contributing touchpoints) for a given profile-based audience segment can be based on a certain propensity associated with the segment (e.g., “Male” users like “Sports”). Given such segmented touchpoint contribution values, for example, the marketing manager might decide to allocate media spending according to the profile-based segment engagement stack 544 if an increase in conversions of users in audience segment a₃ 512 is desired. if the marketing manager only analyzed the response of the audience 352₃ (e.g., see audience engagement stack 342₂), then the marketing manager might allocate media spend so as not to optimally impact users in audience segment a₃ 512.

FIG. 6 depicts a subsystem 600 for determining marketing touchpoint attributions in a segmented media campaign, according to some embodiments, As an option, one or more instances of subsystem 600 or any aspect thereof may be implemented in the context of the architecture and functionality of the embodiments described herein. Also, the subsystem 600 or any aspect thereof may be implemented in any desired environment.

As shown, in some embodiments, a plurality of content 122 and corpus of ads 123 can be presented b the ad server 106 as a set of stimuli 162₂ to the audience 164₃ to produce a set of user interactions 163₂ captured by the data management server 107. A receiving unit 632 in the measurement server 130₂ can receive the stimuli data and the user interactivity data, including touchpoint data, user profile data, and other data(see operation 602) Such data can be used by a model generator 634 to generate a touchpoint attribution predictive model (see operation 604), The touchpoint data, user profile data, and/or model data can be stored in one or more databases (e.g., touchpoint data 124, user profile data 125, and model data 128).

As shown, the apportionment server 140₂ can receive the model parameters from the model generator 634 in the measurement server 130₁ (see operation 612). An instance of the segmented attribution engine 144₃ operating at the apportionment server 140₂ can be used to determine marketing touchpoint attributions in a segmented media campaign. Specifically, the segmented attribution engine 144₃ can determine campaign segments (see operation 614) based, in part, on touchpoint events and/or user profile attributes and/or other data (e.g., marketing manager input). The segmented attribution engine 144₃ can then select the segment touchpoint data records from the set of received touchpoint data records (see operation 616) to generate a set of segmented touchpoint contribution values for the respective segments (see operation 618). The segmented touchpoint contributions values and/or other information can be stored in one or more databases (e.g., attribution data 126). Further, media spend scenario and/or plan information facilitated by the subsystem 600 can be stored in one or more databases planning data 127).

The subsystem 600 presents merely one partitioning. The specific example shown where a measurement server 1302 comprises a receiving unit 632 and a model generator 634, and where an apportionment server 140, comprises a segmented attribution engine 144₃ is purely exemplary, and other partitioning is reasonable, and the partitioning may be defined in part by the volume of empirical data. In some cases a database engine serves to perform calculations (e.g., within or in conjunction with a database engine query). A technique for determining marketing touchpoint attributions in a segmented media campaign implemented in such systems, subsystems, and partitionings is shown in FIG. 7.

FIG. 7 depicts a flowchart 700 for determining marketing touchpoint attributions in a segmented media campaign, according to some embodiments. As an option, one or more instances of flowchart 700 or any aspect thereof may be implemented in the context of the architecture and functionality of the embodiments described herein. Also, the flowchart 700 or any aspect thereof may be implemented in any desired environment.

In one or more embodiments, one or more of the operations comprising the flowchart 700 can be executed by a segmentation attribution engine. As shown, stimulus data records, user interactivity data records, and other data records can be continually collected from the network 108 (see operation 702). For example, the collected interactivity data records can include touchpoint data records (e.g., comprising touchpoint attributes), user profile data records, and other data records that can be stored in one or more databases such as touchpoint data 124 and/or user profile data 125. All or a portion of the collected data can be used to form a touchpoint attribution predictive model 190₃ (see operation 704) Using the collected data (e.g., touchpoint attributes in touchpoint data 124, user profile attributes in user profile data 125, etc. and/or other information, media campaign segments can be determined (see operation 706). For example, segments can be based on selected touchpoint event data (e.g., E(t)) and/or selected user profile data (e.g., A(t)) and/or other data. In some cases, the campaigns segments can be characterized in one or more instances of campaign segment attributes 784, For example, an instance of the campaign segment attributes 784 for a segment might include an identifier for the touchpoints corresponding to a beginning event and an ending event of the segment, and/or an identifier for a user profile category associated with the segment. In one or more embodiments, the segments (e.g., E(t), A(t), etc.) can be predetermined (e.g., by the manager 104₂). In other embodiments, the segments (e.g., E(t), A(t), etc) can be determined based on the collected data.

The events and/or other attributes characterizing the engagement states bounding the segment can then be identified (see operation 708). Using the foregoing information, a set of segment touchpoint data records associated with a given campaign segment can then be selected from the touchpoint data 124 (see operation 710). In some cases, the engagement states identified as bounding the segment can be used to select the segment touchpoint data records. For example, a segment bounded by touchpoint T1 and touchpoint T9 might select all touchpoint data records associated with touchpoints experienced by users between experiencing touchpoint T1 and touchpoint T9. In other cases, the campaign segment attributes 784 can be used to select the segment touchpoint data records. For example, an audience segment might specify the user profile category “Male” in an instance of the campaign segment attributes 784 to facilitate a lookup of all the male UUIDs in the user profile data 125 to be used with the “User” touchpoint attribute to select the segment touchpoint data records. As shown, the selected segment touchpoint data records can comprise a set of segment engagement stacks 742. In some cases, engagement stacks with no touchpoints experienced between the engagement states bounding the segment can be removed from the segment engagement stacks 742 (see operation 712). Such engagement stacks with no intermediate media can represent a conversion bias (e.g., natural converter rate) that is not desired to be included in the data set. Having implemented conversion bias adjustment, the segment engagement stacks 742 can then be applied to the touchpoint attribution predictive model 190₁ to produce a set of segmented touchpoint contribution values 188₂ (see operation 714).

### Additional Practical Application Examples

FIG. 8A is a block diagram of a system 8A00 for determining marketing touchpoint attributions in a segmented media campaign. As shown, system 8A00 comprises at least one processor and at least one memory, the memory serving to store program instructions corresponding to the operations of the system.

As shown, an operation can be implemented in whole or in part using program instructions accessible by a module. The modules are connected to a communication path 8A05, and any operation can communicate with other operations over communication path 8A05. The modules of the system can, individually or in combination, perform method operations within system 8A00. Any operations performed within system 8A00 may be performed in any order unless as may be specified in the claims.

The embodiment of FIG. 8A implements a portion of a computer system, shown as system 8A00, comprising a computer processor to execute a set of program code instructions (see module 8A10) and modules for accessing memory to hold program code instructions to perform: identifying a plurality of touchpoints (see module 8A20); receiving response data for respective ones of the plurality of touchpoints, the response data including an attribute value and an indication value (see module 8A30); determining a plurality of readiness states and a plurality of campaign segments, the respective readiness states associated at least in part with one or more attribute values, and the respective campaign segments describing a change from a first one of the plurality of readiness states to a second one of the plurality of readiness states (see module 8A40); and calculating for the respective campaign segments one or more contribution values for the respective touchpoints, the contribution values derived least in part from the respective indication values, and the contribution values describing a probability of transition from the first one of the plurality of readiness states to the second one of the plurality of readiness states of the respective campaign segment (see module 8A50).

FIG. 8B is a block diagram of a system 8B00 for determining marketing touchpoint attributions in a segmented media campaign. As shown, system 8B00 comprises at least one processor and at least one memory, the memory serving to store program instructions corresponding to the operations of the system. FIG. 8B depicts a block diagram of a system to perform certain functions of a computer system. As an option, the system 8B00 may be implemented in the context of the architecture and functionality of the embodiments described herein. Of course, however, the system 8B00 or any operation therein may be carried out in any desired environment.

The system 8000 comprises at least one processor and at least one memory, the memory serving to store program instructions corresponding to the operations of the system. As shown, an operation can be implemented in whole or in part using program instructions accessible by a module. The modules are connected to a communication path 8B05, and any operation can communicate with other operations over communication path 8B05. The modules of the system can, individually or in combination, perform method operations within system 8B00. Any operations performed within system 8B00 may be performed in any order unless as may be specified in the claims.

The shown embodiment implements a portion of a computer system, presented as system 8B00, comprising a computer processor to execute a set of program code instructions (see module 8B10) and modules for accessing memory to hold program code instructions to perform: identifying one or more users comprising an audience for one or more media campaigns, the users characterized by one or more user profile attributes (see module 8B20); identifying a plurality of touchpoints corresponding to the media campaigns, the touchpoints characterized by one or more touchpoint attributes see module 8B30); receiving, over a network, one or more stimulus data records and one or more user interactivity data records, the user interactivity data records comprising at least one of, one or more touchpoint data records, or one or more user profile data records, the touchpoint data records comprising at least one of the touchpoint attributes, and the user profile data records comprising at least one of the user profile attributes (see module 8B40); forming a touchpoint attribution predictive model formed from at least some of the stimulus data records and at least some of the touchpoint data records (see module 8B50); determining one or more media campaign segments (see module 8B60); selecting one or more segment touchpoint data records from the touchpoint data records associated with the media campaign segments (see module 8B70); and generating one or more segmented touchpoint contribution values for the media campaign segments by applying the segment touchpoint data records to the touchpoint attribution predictive model (see module 8B80).

Variations of the foregoing may include of the foregoing modules and variations may perform more or fewer (or different) steps, and may use data elements in more or fewer (or different) operations. For example, one embodiment commences upon storing a plurality of touchpoint encounter records that represent marketing messages exposed to a plurality of users, wherein the touchpoint encounter records comprise a plurality of touchpoint attributes and the users comprise a plurality of user profile attributes, then sorting the touchpoint encounter records into separate sets: (1) one set comprising converting user data, which comprises touchpoint encounters for users that exhibited a positive response to the marketing message, and (2) another set comprising non-converting user data formed from touchpoint encounters for users that did not exhibit a positive response to the marketing message. Portions of the first set and the second set are used for training a machine-learning model that forms a touchpoint attribution predictive model. The model can be used to predict touchpoint contribution values that reflect importance of the touchpoint attributes. An audience segment for a media campaign can be defined, and/or the predictive model can be consulted to determine one or more audience segments in the media campaign. Upon receiving one or more segment touchpoint encounter records for the users associated with the audience segment the model can again be consulted to retrieve or derive one or more segmented touchpoint contribution values e.g., media campaign effectiveness for the audience segment). Biases in measurements that are introduced from measured interactions by audiences that are not part of the segmented audience are not included if the aforementioned retrievals or derivations. As such, a highly accurate measure of the effectiveness of various touchpoints can be determined by a metric that is specific to the given or derived audience segment.

### Additional System Architecture Examples

FIG. 9A depicts a diagrammatic representation of a machine in the exemplary form of a computer system 9A00 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine,

The computer system 9A00 includes one or more processors (e.g., processor 902₁, processor 902₂, etc,), a main memory comprising one or more main memory segments (e.g., main memory segment 904₁, main memory segment 904₂, etc.), one or more static ones (e.g., static memory 906₁, static memory 906₂, etc.), which communicate with each other via a bus 908. The computer system 9A00 may further include one or more video display units display unit 910₁, display unit 910₂, etc.), such as an LED display, or a liquid crystal display (LCD), or a cathode ray tube (CRT). The computer system 9A00 can also include one or more input devices (e.g., input device 912₁, input device 912₂, alphanumeric input device, keyboard, pointing device, mouse, etc.), one or more database interfaces (e.g., database interface 914₁, database interface 914₂, etc.), one or more disk drive units (e.g., drive unit 916₁, drive unit 916₂, etc.), one or more signal generation devices (e.g., signal generation device 918₁, signal generation device 918₂, etc.), and one or more network interface devices (e.g., network interface device 920₁, network interface device 920², etc.).

The disk drive units can include one or more instances of a machine-readable medium 924 on which is stored one or more instances of a data table 919 to store electronic information records. The machine-readable medium 924 can further store a set of instructions 926₀ (e.g., software) embodying any one, or all, of the methodologies described above. A set of instructions 926₁ can also be stored within the main memory (e.g., in main memory segment 904₁). Further, a set of instructions 926₂ can also be stored within the one or more processors (e.g., processor 902₁). Such instructions and/or electronic information may further be transmitted or received via the network interface devices at one or more network interface ports (e.g., network interface port 923₁, network interface port 923₂, etc.). Specifically, the network interface devices can communicate electronic information across a network using one or more optical links, Ethernet links, wireline links, wireless links, and/or other electronic communication links (e.g., communication link 922₁, communication link 922₂, etc.). One or more network protocol packets (e.g., network protocol packet 921₁, network protocol packet 921₂, etc.) can be used to hold the electronic information (e.g., electronic data records) for transmission across an electronic communications network (e.g., network 948). In some embodiments, the network 948 may include, without limitation, the web (i.e., the Internet), one or more local area networks (LANs), one or more wide area networks (WANs), one or more wireless networks, and/or one or more cellular networks.

The computer system 9A00 can be used to implement a client system and/or a server system, and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine e.g., a computer). For example, a machine-readable medium includes read-only memory (ROM); random access memory (RAM); magnetic disk storage media; optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as one or more processors (e.g., processor 902₁, processor 902₂, etc.).

FIG. 9B depicts a block diagram of a data processing system suitable for implementing instances of the herein-disclosed embodiments. The data processing system may include many more or fewer components than those shown.

The components of the data processing system may communicate electronic information (e.g., electronic data records) across various instances and/or types of an electronic communications network (e.g., network 948) using one or more electronic communication links (e.g., communication link 922₁, communication link 922₂, etc.). Such communication links may further use supporting hardware, such as modems, bridges, routers, switches, wireless antennas and towers, and/or other supporting hardware. The various communication links transmit signals comprising data and commands (e.g., electronic data records) exchanged by the components of the data processing system, as well as any supporting hardware devices used to transmit the signals, In some embodiments, such signals are transmitted and received by the components at one or more network interface ports (e.g., network interface port 923₁, network interface port 923₂, etc.). In one or more embodiments, one or more network protocol packets (e.g., network protocol packet 921₁, network protocol packet 921₂, etc) can be used to hold the electronic information comprising the signals.

As shown, the data processing system can be used by one or more advertisers to target a set of subject users 980 (e.g., user 983₁, user 983₂, user 983₃, user 983₄, user 983₅, to user 983_{N}) in various media campaigns. The data processing system can further be used to determine, by an analytics computing platform 930, various characteristics (e.g., performance metrics, etc.) of such media campaigns. Other operations, transactions, and/or activities associated with the data processing system are possible. Specifically, the subject users 980 can receive a plurality of online message data 953 transmitted through any of a plurality of online delivery paths 976 (e.g., online display, search, mobile ads, etc.) to various computing devices (e.g., desktop device 982₁, laptop device 982₂, mobile device 982₃, and wearable device 982₄). The subject users 980 can further receive a plurality of offline message data 952 presented through any of a plurality of offline delivery paths 978 (e.g., TV radio, print, direct mail, etc.). The online message data 953 and/or the offline message data 952 can be selected for delivery to the subject users 980 based in part on certain instances of campaign specification data records 974 (e.g., established by the advertisers and/or the analytics computing platform 930). For example, the campaign specification data records 974 might comprise settings, rules, taxonomies, and other information transmitted electronically to one or more instances of online delivery computing systems 946 and/or one or more instances of offline delivery resources 944. The online delivery computing systems 946 and/or the offline delivery resources 944 can receive and store such electronic information in the form of instances of computer files 984₂ and computer files 984₃, respectively. In one or more embodiments, the online delivery computing systems 946 can comprise computing resources such as an online publisher website server 962, an online publisher message server 964, an online marketer message server 966, an online message delivery server 968, and other computing resources. For example, the message data record 970₁ presented to the subject users 980 through the online delivery paths 976 can be transmitted through the communications links of the data processing system as instances of electronic data records using various protocols (e.g., HTTP, HTTPS, etc.) and structures (e.g., JSON), and rendered on the computing devices in various forms (e.g., digital picture, hyperlink, advertising tag, text message, email message, etc.). The message data record 970₃ presented to the subject users 980 through the offline delivery paths 978 can be transmitted as sensory signals in various forms (e.g., printed pictures and text, video, audio, etc.).

The analytics computing platform 930 can receive instances of an interaction event data record 972 comprising certain characteristics and attributes of the response of the subject users 980 to the message data record 970₁, the message data record 970₂, and/or other received messages. For example, the interaction event data record 972 can describe certain online actions taken by the users on the computing devices, such as visiting a certain URL, clicking a certain link, loading a web page that fires a certain advertising tag, completing an online purchase, and other actions. The interaction event data record 972 may also include information pertaining to certain offline actions taken by the users, such as purchasing a product in a retail store, using a printed coupon, dialing a toll-free number, and other actions. The interaction event data record 972 can be transmitted to the analytics computing platform 930 across the communications links as instances of electronic data records using various protocols and structures. The interaction event data record 972 can further comprise data (e.g., user identifier, computing device identifiers, timestamps, IP addresses, etc.) related to the users and/or the users' actions.

The interaction event data record 972 and other data generated and used by the analytics computing platform 930 can be stored a storage device having one or more storage partitions 950 (e.g., message data store 954, interaction data store 955, campaign metrics data store 956, campaign plan data store 957, subject user data store 958, etc.). The storage partitions 950 can comprise one or more databases and/or other types of non-volatile storage facilities to store data in various formats and structures (e.g., data tables 982, computer files 984₁, etc.). The data stored in the storage partitions 950 can be made accessible to the analytics computing platform 930 by a query processor 936 and a result processor 937, which can use various means for accessing and presenting the data, such as a primary key index 983 and/or other means. In one or more embodiments, the analytics computing platform 930 can comprise a performance analysis server 932 and a campaign planning server 934. Operations performed by the performance analysis server 932 and the campaign planning server 934 can vary widely by embodiment. As an example, the performance analysis server 932 can be used to analyze the messages presented to the users (e.g., message data record 970₁ and message data record 970₂) and the associated instances of the interaction event data record 972 to determine various performance metrics associated with a media campaign, which metrics can be stored in the campaign metrics data store 956 and/or used to generate various instances of the campaign specification data records 974. Further, for example, the campaign planning server 934 can be used to generate media campaign plans and associated marketing spend apportionments, which information can be stored in the campaign plan data store 957 and/or used to generate various instances of the campaign specification data records 974. Certain portions of the interaction event data record 972 might further be used by a data management platform server 938 in the analytics computing platform 930 to determine various user attributes (e.g., behaviors, intent, demographics, device usage, etc.), which attributes can be stored in the subject user data store 958 and/or used to generate various instances of the campaign specification data records 974. One or more instances of an interface application server 935 can execute various software applications that can manage and/or interact with the operations, transactions, data, and/or activities associated with the analytics computing platform 930. For example, a marketing manager might interface with the interface application server 935 to view the performance of a media campaign and/or to allocate media spend for another media campaign.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A computer implemented method comprising:
storing data in a computer, the data forming a plurality of touchpoint encounter records that represent marketing messages exposed to a plurality of users, wherein the touchpoint encounter records comprise a plurality of touchpoint attributes and the users comprise a plurality of user profile attributes;
sorting the data for the touchpoint encounter records in the computer to separate into converting user data, which comprises touchpoint encounters for users that exhibited a positive response to the marketing message, and non-converting user data that comprises touchpoint encounters for users that exhibited a negative response to the marketing message;
retrieving, from storage, the converting user data and the non-converting user data;
training, using machine-learning techniques in a computer, the converting user data and the non-converting user data as training data to generate a touchpoint attribution predictive model that predicts a plurality of touchpoint contribution values that reflect importance of the touchpoint attributes and the user profile attributes to the response of the marketing message;
identifying one or more users that comprise an audience for a media campaign;
determining one or more media campaign segments in the media campaign;
receiving one or more segment touchpoint encounter records for the users associated with the media campaign segments; and
generating one or more segmented touchpoint contribution values for the media campaign segments by applying the segment touchpoint encounter records to the touchpoint attribution predictive model.

2. The computer implemented method of claim 1, wherein at least one of the media campaign segments is derived from at least one of, the touchpoint attributes, or the user profile attributes.

3. The computer implemented method of claim 1, wherein selecting the segment touchpoint encounter records is based at least in part on a relationship between at least one touchpoint attribute and at least one user profile attribute.

4. The computer implemented method of claim 1, wherein selecting the segment touchpoint encounter records further comprises removing a portion of the segment touchpoint encounter records associated with a conversion bias.

5. The computer implemented method of claim 1, wherein at least one of the media campaign segments is characterized by a first engagement state and a second engagement state.

6. The computer implemented method of claim 5, wherein the segmented touchpoint contribution values characterize a measure of an influence attributed to at least one of the touchpoints in transitioning at least one of the users from the first engagement state to the second engagement state.

7. The computer implemented method of claim 5, wherein at least one of the first engagement state, or the second engagement state, is associated with at least one of, the touchpoint attributes, or the user profile attributes.

8. The computer implemented method of claim 5, wherein at least one of, the first engagement state, or the second engagement state, is characterized by a propensity score.

9. The computer implemented method of claim 5, wherein transitioning from the first engagement state to the second engagement state is characterized by at least one of, a transition probability, or a conversion probability.

10. The computer implemented method of claim 1, further comprising providing a media planning application to at least one application user for operation on at least one management interface device, wherein determining the media campaign segments is based at least in part on information received from the media planning application over a network.

11. A computer readable medium, embodied in a non-transitory computer readable medium, the non-transitory computer readable medium having stored thereon a sequence of instructions which, when stored in memory and executed by a processor causes the processor to perform a set of acts, the acts comprising:
storing data in a computer, the data forming a plurality of touchpoint encounter records that represent marketing messages exposed to a plurality of users, wherein the touchpoint encounter records comprise a plurality of touchpoint attributes and the users comprise a plurality of user profile attributes;
sorting the data for the touchpoint encounter records in the computer to separate into converting user data, which comprises touchpoint encounters for users that exhibited a positive response to the marketing message, and non-converting user data that comprises touchpoint encounters for users that exhibited a negative response to the marketing message;
retrieving, from storage, the converting user data and the non-converting user data;
training, using machine-learning techniques in a computer, the converting user data and the non-converting user data as training data to generate a touchpoint attribution predictive model that predicts a plurality of touchpoint contribution values that reflect importance of the touchpoint attributes and the user profile attributes to the response of the marketing message;
identifying one or more users that comprise an audience for a media campaign;
determining one or more media campaign segments in the media campaign;
receiving one or more segment touchpoint encounter records for the users associated with the media campaign segments; and
generating one or more segmented touchpoint contribution values for the media campaign segments by applying the segment touchpoint encounter records to the touchpoint attribution predictive model.

12. The computer readable medium of claim 11, wherein at least one of the media campaign segments is derived from at least one of the touchpoint attributes, or the user profile attributes.

13. The computer readable medium of claim 11, wherein selecting the segment touchpoint encounter records is based at least in part on a relationship between at least one touchpoint attribute and at least one user profile attribute.

14. The computer readable medium of claim 11, wherein selecting the segment touchpoint encounter records further comprises removing a portion of the segment touchpoint encounter records associated with a conversion bias.

15. The computer readable medium of claim 11, wherein at least one of the media campaign segments is characterized by a first engagement state and a second engagement state.

16. The computer readable medium of claim 15, wherein the segmented touchpoint contribution values characterize a measure of an influence attributed to at least one of the touchpoints in transitioning at least one of the users from the first engagement state to the second engagement state.

7. The computer readable medium of claim 15, wherein at least one of, the first engagement state, or the second engagement state, is characterized by a propensity score.

18. The computer readable medium of claim 15, wherein transitioning from the first engagement state to the second engagement state is characterized by at least one of, a transition probability, or a conversion probability.

19. A system comprising:
a storage device to store data comprising a plurality of touchpoint encounter records that represent marketing messages exposed to a plurality of users, wherein the touchpoint encounter records comprise a plurality of touchpoint attributes and the users comprise a plurality of user profile attributes; and
a processor for executing instructions which, when stored in a memory and executed by the processor causes the processor to perform,
sorting the data for the touchpoint encounter records o separate into converting user data which comprises touchpoint encounters for users that exhibited a positive response to the marketing message, and non-converting user data that comprises touchpoint encounters for users that exhibited a negative response to the marketing message;
retrieving, from the storage device, the converting user data and the non-converting user data;
training, using machine-learning techniques, the converting user data and the non-converting user data as training data to generate a touchpoint attribution predictive model that predicts a plurality of touchpoint contribution values that reflect importance of the touchpoint attributes and the user profile attributes to the response of the marketing message;
identifying one or more users that comprise an audience for a media campaign;
determining one or more media campaign segments in the media campaign;
receiving one or more segment to touchpoint encounter records for the users associated with the media campaign segments; and
generating one or more segmented touchpoint contribution values for the media campaign segments by applying the segment touchpoint encounter records to the touchpoint attribution predictive model.

20. The system of claim 19, wherein at least one of the media campaign segments is derived from at least one of, the touchpoint attributes, or the user profile attributes.
